(19) United States
(12) Patent Application Publication
(10) Pub. No.: US 2021/0347935 A1
(43) Pub. Date: Nov. 11, 2021

(54) POLYMERS FOR SPECIALTY APPLICATIONS

(71) Applicant: MATERIA, INC., Pasadena, CA (US)

(72) Inventors: Jennifer A. BEERMAN, Monrovia, CA (US); Alexandria K. DUNCAN, Cleveland, OH (US); Brian D. EDGECOMBE, Anaheim, CA (US); Kristina GOULINIAN, Glendale, CA (US); Jessica R. HERRON, Pasadena, CA (US); John H. PHILLIPS, Pasadena, CA (US)

(21) Appl. No.: 17/280,991

(22) PCT Filed: Oct. 3, 2019
(86) PCT No.: PCT/US2019/054503

§ 371 Date: Mar. 29, 2021

Related U.S. Application Data
(60) Provisional application No. 62/740,443, filed on Oct. 3, 2018.

(51) Int. Cl. C08G 61/08; B01J 31/22

(52) U.S. Cl. CPC C08G 61/08; B01J 31/2278; C08G 2261/3324; C08G 2261/418; C08G 2261/1426; B01J 2231/543; C08G 2261/1412; C08G 2261/1414; C08G 2261/65; B01J 2531/821; C08G 2261/1424

(57) ABSTRACT

The invention relates to ring-opening metathesis polymerization (ROMP) reactions of making polymers suitable for the electronic industry. Particularly, the invention relates to novel polymers with low dielectric constant (Dₖ) and low dielectric loss (D_{f}) suited for smaller, lighter, higher speeds and higher frequency transmission electronic products. Such polymers can be used in a variety of materials and composites of the printed circuit board (PCB) industry.

### RELATED APPLICATIONS

This application claims the benefit of U.S. Provisional Patent Application No. 62/740,443, filed Oct. 3, 2018, the contents of which are incorporated herein by reference.

### TECHNICAL FIELD

The invention relates to ring-opening metathesis polymerization (ROMP) reactions of making polymers suitable for the electronic industry. Particularly, the invention relates to novel polymers with low dielectric constant (Dₖ) and low dielectric loss (D_{f}) suited for smaller, lighter, higher speeds and higher frequency transmission electronic products. Such polymers can be used in a variety of materials and composites of the printed circuit board (PCB) industry.

### BACKGROUND

Olefin metathesis has emerged as a unique and powerful transformation for the interconversion of olefinic hydrocarbons, namely due to the development of well-defined catalysts. See Grubbs, R. H. Handbook of Metathesis, (Wiley-VCH: Weinheim, Germany 2003). The exceptionally wide scope of substrates and functional group tolerances makes olefin metathesis a valuable technique that quickly and efficiently produces otherwise hard to make molecules, compared to traditional synthetic organic techniques. In particular, certain ruthenium and osmium olefin metathesis catalysts, known as “Grubbs catalysts,” have been identified as effective catalysts for olefin metathesis reactions such as: cross metathesis (CM), ring-closing metathesis (RCM), ring-opening metathesis (ROM), ring-opening cross metathesis (ROCM), ring-opening metathesis polymerization (ROMP) and acyclic diene metathesis (ADMET) polymerization. The use of such catalysts has greatly expanded the scope of olefin metathesis due to increased tolerance of organic functionality to moisture and oxygen.

Polymers prepared by ROMP of cyclic olefins, particularly polymers based on norbornene, are suitable for PCB prepreg (resin-impregnated glass fabrics) and copper-clad laminate (CCL), due to their electric properties.

The two main “building blocks” of a modern multi-layered PCB are CCL and prepreg. CCL is the primary structure which provides copper on a stable electrically insulating substrate which after lithography steps yields the copper traces. Prepreg allows layers of CCL to be bonded together after processing steps such as photolithography, drilling, and copper plating have been performed to achieve a multi-layered PCB. Prepreg has a role analogous to “double-sided tape” in adhering layers of CCL together but with the added benefit of being truly conformable since it melts and flows during high temperature bonding step. In fact, CCL is produced directly from prepreg and copper foil through a heat curing step in a special press. The quality/effectiveness of the electrical insulation between copper traces on a PCB are dependent on the Dₖ and D_{f} of the CCL and the prepreg. The major contributor to Dₖ and D_{f}, is the polymer.

The inventors have discovered a series of readily soluble polymers of low to medium molecular weight, suitable for the PCB prepreg and CCL manufacturing processes. These polymers were prepared using ROMP of specialty monomers and metal carbene olefin metathesis catalysts. This discovery, as described and exemplified herein, was surprising and unexpected in view of the teachings in the art.

### SUMMARY OF THE INVENTION

The invention provides polymers with improved dielectric constant (Dk) and dielectric loss (Df) compared to the prior art. Additional aspects and advantages of the invention include polymers with good processability, crosslink-ability, and high glass transition temperatures (Tg). The polymers may be suitably formulated in a solvent based varnish or in melt-processing step to improve other properties, such as adhesion to copper foil or coefficient of thermal expansion (CTE).

The process employed to produce the polymers is based on ring opening metathesis polymerization using at least one metal carbene olefin metathesis catalyst in the presence of at least one functionalized monomer, at least one optional olefin, and at least one optional solvent. The polymer can be separated from unreacted catalyst(s) and monomer(s).

The polymers of the invention can be synthesized according to synthetic Scheme 1:

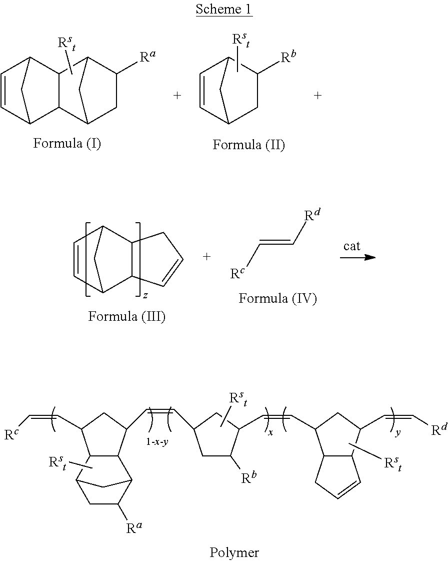

wherein:

“cat” represents a metal carbene olefin metathesis catalyst;

z is 0, 1, 2, or 3;

x and y are, independently of one another, a molar fraction of between 0 and 1 or equal to 0 or 1,

R^{a} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, —CN, —NO₂, —CF₃, —P(O)(OH)₂, —OP(O)(OH)₂, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₀ cycloalkenyl, or —CH₂-(optionally substituted C₃₋₈ cycloalkenyl);

R^{b} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, —CN, —NO₂, —CF₃, —P(O)(OH)₂, —OP(O)(OH)₂, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₈ cycloalkenyl, or —CH₂-(optionally substituted C₃₋₈ cycloalkenyl);

R^{c} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₈ cycloalkenyl, —CH₂-(optionally substituted C₃₋₈ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;

R^{d} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₈ cycloalkenyl, —CH₂-(optionally substituted C₃₋₈ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;

each R^{s} is independently optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₈ cycloalkenyl, —CH₂-(optionally substituted C₃₋₈ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), or —C(R^{h})(Rⁱ)C(O)NR^{o}R^{p}, —C(R^{h})(Rⁱ)C(O)NR^{o}ORⁿ;

t is 0, 1, 2, 3, 4, 5, or 6;

R^{f} is OH, OR^{k}, NR^{g}R^{h}, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{g} is H, optionally substituted C₁₋₂₄ alkyl, optionally substituted C₃₋₁₀ cycloalkyl, optionally substituted heterocycle, optionally substituted C₅₋₂₄ aryl, optionally substituted linear or branched C₂₋₆ alkenyl, —C(O)-(optionally substituted linear or branched C₂₋₆ alkenyl), or optionally substituted C₃₋₈ cycloalkenyl;

R^{h} is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

Rⁱ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{j} is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{k} is optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{l} is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{m} is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

Rⁿ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{o} is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl; and

R^{p} is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl.

### BRIEF DESCRIPTION OF THE DRAWINGS

FIG. 1 depicts the complex viscosity as a function of temperature of polymer 26.

### DETAILED DESCRIPTION

### Terminology and Definitions

Unless otherwise indicated, the invention is not limited to specific reactants, reaction conditions, or the like, as such may vary. It is also to be understood that the terminology used herein is for the purpose of describing particular embodiments and is not to be interpreted as being limiting.

As used in the specification and the appended claims, the singular forms “a,” “an,” and “the” include plural referents unless the context clearly dictates otherwise. Thus, for example, reference to “a substituent” encompasses a single substituent as well as two or more substituents, and the like.

As used in the specification and the appended claims, the terms “for example,” “for instance,” “such as,” or “including” are meant to introduce examples that further clarify more general subject matter. Unless otherwise specified, these examples are provided only as an aid for understanding the invention and are not meant to be limiting in any fashion.

In this specification and in the claims that follow, reference will be made to a number of terms, which shall be defined to have the meanings as described herein.

The term “alkyl” refers to a linear, branched, saturated hydrocarbon group typically containing 1 to 24 carbon atoms, preferably 1 to 12 carbon atoms, more preferably 1 to 6 carbon atoms: such as methyl (Me), ethyl (Et), n-propyl (Pr or n-Pr), isopropyl (i-Pr), n-butyl (Bu or n-Bu), isobutyl (i-Bu), t-butyl (t-Bu), octyl (Oct), decyl, and the like.

The term “cycloalkyl” refers to a cyclic alkyl group, can be monocyclic, bicyclic or polycyclic, typically having 3 to 10, preferably 5 to 7, carbon atoms, generally, cycloalkyl groups are cyclopentyl (Cp), cyclohexyl (Cy), or adamantyl.

The term “substituted alkyl” refers to alkyl substituted with one or more substituent groups, and the terms “heteroatom-containing alkyl” and “heteroalkyl” refer to alkyl in which at least one carbon atom is replaced with a heteroatom.

The term “alkylene” refers to a difunctional linear, branched alkyl group, where “alkyl” is as defined above.

The term “alkenyl” refers to a linear, branched hydrocarbon group of 2 to 24 carbon atoms containing at least one double bond, such as ethenyl, n-propenyl, iso-propenyl, n-butenyl, iso-butenyl, octenyl, decenyl, tetradecenyl, hexadecenyl, and the like. Preferred alkenyl groups herein contain 2 to 12 carbon atoms, more preferred alkenyl groups herein contain 2 to 6 carbon atoms.

The term “substituted alkenyl” refers to alkenyl substituted with one or more substituent groups, and the terms “heteroatom-containing alkenyl” and “heteroalkenyl” refer to alkenyl in which at least one carbon atom is replaced with a heteroatom.

The term “cycloalkenyl” refers to a cyclic alkenyl group, preferably having 3 to 8 carbon atoms.

The term “alkenylene” refers to a difunctional linear, branched, where “alkenyl” is as defined above.

The term “alkynyl” refers to a linear or branched hydrocarbon group of 2 to 24 carbon atoms containing at least one triple bond, such as ethynyl, n-propynyl, and the like. Preferred alkynyl groups herein contain 2 to 12 carbon atoms, more preferred alkynyl groups herein contain 2 to 6 carbon atoms.

The term “substituted alkynyl” refers to alkynyl substituted with one or more substituent groups, and the terms “heteroatom-containing alkynyl” and “heteroalkynyl” refer to alkynyl in which at least one carbon atom is replaced with a heteroatom.

The term “alkynylene” refers to a difunctional alkynyl group, where “alkynyl” is as defined above.

The term “alkoxy” refers to an alkyl group bound through a single, terminal ether linkage; that is, an “alkoxy” group may be represented as —O-alkyl where “alkyl” is as defined above. Analogously, “alkenyloxy” refers to an alkenyl group bound through a single, terminal ether linkage, and “alkynyloxy” refers to an alkynyl group bound through a single, terminal ether linkage.

The term “aryl,” unless otherwise specified, refers to an aromatic substituent containing a single aromatic ring or multiple aromatic rings that are fused together, directly linked, or indirectly linked (such that the different aromatic rings are bound to a common group such as a methylene or ethylene moiety). Preferred aryl groups contain 5 to 24 carbon atoms, and particularly preferred aryl groups contain 6 to 10 carbon atoms. Exemplary aryl groups contain one aromatic ring or two fused or linked aromatic rings, e.g., phenyl (Ph), naphthyl, biphenyl, diphenylether, diphenylamine, benzophenone, phenanthryl, and the like.

“Substituted aryl” refers to an aryl moiety substituted with one or more substituent groups, and the terms “heteroatom containing aryl” and “heteroaryl” refer to aryl substituents in which at least one carbon atom is replaced with a heteroatom, as will be described in further detail herein.

The term “aryloxy” refers to an aryl group bound through a single, terminal ether linkage, wherein “aryl” is as defined above. An “aryloxy” group may be represented as —O-aryl where aryl is as defined above. Preferred aryloxy groups contain 5 to 24 carbon atoms, and particularly preferred aryloxy groups contain 6 to 10 carbon atoms. Examples of aryloxy groups include, without limitation, phenoxy, o-halo-phenoxy, m-halo-phenoxy, p-halo-phenoxy, o-methoxy-phenoxy, m-methoxy-phenoxy, p-methoxy-phenoxy, 2,4-dimethoxy-phenoxy, 3,4,5-trimethoxy-phenoxy, and the like.

The term “alkaryl” refers to an aryl group with an alkyl substituent, and the term “aralkyl” refers to an alkyl group with an aryl substituent, wherein “aryl” and “alkyl” are as defined above. Preferred alkaryl and aralkyl groups contain 6 to 24 carbon atoms, and particularly preferred alkaryl and aralkyl groups contain 6 to 16 carbon atoms. Alkaryl groups include, without limitation, p-methylphenyl, 2,4-dimethylphenyl, p-cyclohexylphenyl, 2,7-dimethylnaphthyl, 7-cyclooctylnaphthyl, 3-ethyl-cyclopenta-1,4-diene, and the like. Examples of aralkyl groups include, without limitation, benzyl, 2-phenyl-ethyl, 3-phenyl-propyl, 4-phenyl-butyl, 5-phenyl-pentyl, 4-phenylcyclohexyl, 4-benzylcyclohexyl, 4-phenylcyclohexylmethyl, 4-benzylcyclohexylmethyl, and the like.

The terms “alkaryloxy” and “aralkyloxy” refer to substituents of the formula —OR wherein R is alkaryl or aralkyl, respectively, as defined herein.

The term “acyl” refers to substituents having the formula —(CO)-alkyl, —(CO)-aryl, —(CO)-aralkyl, —(CO)-alkaryl, —(CO)-alkenyl, or —(CO)-alkynyl, and the term “acyloxy” refers to substituents having the formula —O(CO)-alkyl, —O(CO)-aryl, —O(CO)-aralkyl, —O(CO)-alkaryl, —O(CO)-alkenyl, or —(CO)-alkynyl wherein “alkyl,” “aryl,” “aralkyl,” “alkaryl,” “alkenyl,” and “alkynyl” are as defined above. The acetoxy group (—O(CO)CH₃, often abbreviated as —OAc) is a common example of an acyloxy group.

The terms “cyclic” and “ring” refer to alicyclic or aromatic groups that may or may not be substituted and/or heteroatom containing, and that may be monocyclic, bicyclic, or polycyclic. The term “alicyclic” is used in the conventional sense to refer to an aliphatic cyclic moiety, as opposed to an aromatic cyclic moiety, and may be monocyclic, bicyclic, or polycyclic.

The term “polycyclic ring” refers to alicyclic or aromatic groups that may or may not be substituted and/or heteroatom containing, and that have at least two closed rings tethered, fused, linked via a single bond or bridged. Polycyclic rings include without limitation naphthyl, biphenyl, phenanthryl and the like.

The term “spiro compound” refers to a chemical compound, that presents a twisted structure of two or more rings (a ring system), in which 2 or 3 rings are linked together by one common atom,

The terms “halo” and “halogen” and “halide” are used in the conventional sense to refer to a fluorine (F), chlorine (Cl), bromine (Br), or iodine (I) substituent.

“Hydrocarbyl” refers to univalent hydrocarbyl moieties containing 1 to 24 carbon atoms, preferably 1 to 12 carbon atoms, including linear, branched, cyclic, saturated and unsaturated species, such as alkyl groups, alkenyl groups, alkynyl groups, aryl groups, and the like. “Substituted hydrocarbyl” refers to hydrocarbyl substituted with one or more substituent groups.

“Hydrocarbylene” refers to divalent hydrocarbyl moieties containing 1 to 24 carbon atoms, preferably 1 to 12 carbon atoms, including linear, branched, cyclic, saturated and unsaturated species, formed by removal of two hydrogens from a hydrocarbon. “Substituted hydrocarbylene” refers to hydrocarbylene substituted with one or more substituent groups.

The term “heteroatom-containing” as in a “heteroatom-containing hydrocarbyl group” refers to a hydrocarbon molecule or a hydrocarbyl molecular fragment in which one or more carbon atoms is replaced with an atom other than carbon, e.g., nitrogen, oxygen, sulfur, phosphorus or silicon, typically nitrogen, oxygen, or sulfur. The terms “heteroatom-containing hydrocarbylene” and “heterohydrocarbylene” refer to hydrocarbylene in which at least one carbon atom is replaced with a heteroatom. Similarly, the term “heteroalkyl” refers to an alkyl substituent that is heteroatom-containing, the term “heterocyclic” refers to a cyclic substituent that is heteroatom-containing, the terms “heteroaryl” and “heteroaromatic” respectively refer to “aryl” and “aromatic” substituents that are heteroatom-containing, and the like. It should be noted that a “heterocyclic” group or compound may or may not be aromatic, and further that “heterocycles” may be monocyclic, bicyclic, or polycyclic as described above with respect to the term “aryl.” Examples of heteroalkyl groups include without limitation alkoxyaryl, alkylsulfanyl-substituted alkyl, N-alkylated amino alkyl, and the like. Examples of heteroaryl substituents include without limitation pyrrolyl, pyrrolidinyl, pyridinyl, quinolinyl, indolyl, pyrimidinyl, imidazolyl, 1,2,4-triazolyl, tetrazolyl, etc., and examples of heteroatom-containing alicyclic groups include without limitation pyrrolidino, morpholino, piperazino, piperidino, etc.

In addition, the aforementioned substituent groups may, if a particular group permits, be further substituted with one or more additional substituent groups or with one or more hydrocarbyl moieties such as those specifically enumerated above. Analogously, the above mentioned hydrocarbyl moieties may be further substituted with one or more substituent groups or additional hydrocarbyl moieties such as those specifically mentioned above. Analogously, the above-mentioned hydrocarbylene moieties may be further substituted with one or more substituent groups or additional hydrocarbyl moieties as noted above.

By “substituted” as in “substituted hydrocarbyl,” “substituted alkyl,” “substituted aryl,” and the like, as alluded to in some of the aforementioned definitions, is meant that in the hydrocarbyl, alkyl, aryl, or other moiety, at least one hydrogen atom bound to a carbon (or other) atom is replaced with one or more non-hydrogen substituents. Examples of such substituents include, without limitation groups such as halo, hydroxyl, sulfhydryl, C₁-C₂₄ alkoxy, C₂-C₂₄ alkenyloxy, C₂-C₂₄ alkynyloxy, C₅-C₂₄ aryloxy, C₆-C₂₄ aralkyloxy, C₆-C₂₄ alkaryloxy, acyl (including C₂-C₂₄ alkylcarbonyl (—CO-alkyl) and C₆-C₂₄ arylcarbonyl (—CO-aryl)), acyloxy (—O-acyl, including C₂-C₂₄ alkylcarbonyloxy (—O—CO-alkyl) and C₆-C₂₄ arylcarbonyloxy (—O—CO-aryl)), C₂-C₂₄ alkoxycarbonyl (—(CO)—O-alkyl), C₆-C₂₄ aryloxycarbonyl (—(CO)—O-aryl), halocarbonyl (—CO)—X where X is halo), C₂-C₂₄ alkylcarbonato (—O—(CO)—O-alkyl), C₆-C₂₄ arylcarbonato (—O—(CO)—O-aryl), carboxylic acid (—COOH), carbamoyl (—(CO)—NH₂), mono-(C₁-C₂₄ alkyl)-substituted carbamoyl (—(CO)—NH(C₁-C₂₄ alkyl)), di-(C₁-C₂₄ alkyl)-substituted carbamoyl (—(CO)—N(C₁-C₂₄ alkyl)₂), mono-(C₁-C₂₄ haloalkyl)-substituted carbamoyl (—(CO)—NH(C₁-C₂₄ haloalkyl)), di-(C₁-C₂₄ haloalkyl)-substituted carbamoyl (—(CO)—N(C₁-C₂₄ haloalkyl)₂), mono-(C₅-C₂₄ aryl)-substituted carbamoyl (—(CO)—NH-aryl), di-(C₅-C₂₄ aryl)-substituted carbamoyl (—(CO)—N(C₅-C₂₄ aryl)₂), N(C₁-C₂₄ alkyl)(C₅-C₂₄ aryl)-substituted carbamoyl (—(CO)—N(C₁-C₂₄ alkyl)(C₅-C₂₄ aryl), thiocarbamoyl (—(CS)—NH₂), mono-(C₁-C₂₄ alkyl)-substituted thiocarbamoyl (—(CS)—NH(C₁-C₂₄ alkyl)), di-(C₁-C₂₄ alkyl)-substituted thiocarbamoyl (—(CS)—N(C₁-C₂₄ alkyl)₂), mono-(C₅-C₂₄ aryl)-substituted thiocarbamoyl (—(CS)—NH-aryl), di-(C₅-C₂₄ aryl)-substituted thiocarbamoyl (—(CS)—N(C₅-C₂₄ aryl)₂), N(C₁-C₂₄ alkyl)(C₅-C₂₄ aryl)-substituted thiocarbamoyl (—(CS)—N(C₁-C₂₄ alkyl)(C₅-C₂₄ aryl), carbamido (—NH—(CO)—NH₂), cyano (—C≡N), cyanato (—O—C≡N), thiocyanato (—S—C≡N), isocyanate (—NCO), thioisocyanate (—NCS), formyl (—(CO)—H), thioformyl (—(CS)—H), amino (—NH₂), mono-(C₁-C₂₄ alkyl)-substituted amino (—NH(C₁-C₂₄ alkyl), di-(C₁-C₂₄ alkyl)-substituted amino ((—N(C₁-C₂₄ alkyl)₂), mono-(C₅-C₂₄ aryl)-substituted amino (—NH(C₅-C₂₄ aryl), di-(C₅-C₂₄ aryl)-substituted amino (—N(C₅-C₂₄ aryl)₂), C₂-C₂₄ alkylamido (—NH—(CO)-alkyl), C₆-C₂₄ arylamido (—NH—(CO)-aryl), imino (—CRNH where, R includes without limitation H, C₁-C₂₄ alkyl, C₅-C₂₄ aryl, C₆-C₂₄ alkaryl, C₆-C₂₄ aralkyl, etc.), C₂-C₂₀ alkylimino (—CRN(alkyl), where R includes without limitation H, C₁-C₂₄ alkyl, C₅-C₂₄ aryl, C₆-C₂₄ alkaryl, C₆-C₂₄ aralkyl, etc.), arylimino (—CRN(aryl), where R includes without limitation H, C₁-C₂₀ alkyl, C₅-C₂₄ aryl, C₆-C₂₄ alkaryl, C₆-C₂₄ aralkyl, etc.), nitro (—NO₂), nitroso (—NO), sulfo (—S(O)₂OH), C₁-C₂₄ alkylsulfanyl (—S-alkyl; also termed “alkylthio”), C₅-C₂₄ arylsulfanyl (—S-aryl; also termed “arylthio”), C₁-C₂₄ alkylsulfinyl (—(SO)-alkyl), C₅-C₂₄ arylsulfinyl (—(SO)-aryl), C₁-C₂₄ alkylsulfonyl (—SO₂-alkyl), C₁-C₂₄ monoalkylaminosulfonyl (—SO₂—N(H) alkyl), C₁-C₂₄ dialkylaminosulfonyl (—SO₂—N(alkyl)₂), C₅-C₂₄ arylsulfonyl (—SO₂-aryl), boryl (—BH₂), borono (—B(OH)₂), boronato (—B(OR)₂ where R includes without limitation alkyl or other hydrocarbyl), phosphono (—P(O)(OH)₂), phospho (—PO₂), phosphino (—PH₂), silyl (—SiR₃ wherein R is H or hydrocarbyl), and silyloxy (—O-silyl); hydrocarbyl moieties C₁-C₂₄ alkyl (preferably C₁-C₁₂ alkyl, more preferably C₁-C₆ alkyl), C₂-C₂₄ alkenyl (preferably C₂-C₁₂ alkenyl, more preferably C₂-C₆ alkenyl), C₂-C₂₄ alkynyl (preferably C₂-C₁₂ alkynyl, more preferably C₂-C₆ alkynyl), C₅-C₂₄ aryl (preferably C₆-C₁₀ aryl), C₆-C₂₄ alkaryl (preferably C₆-C₁₆ alkaryl), or C₆-C₂₄ aralkyl (preferably C₆-C₁₆ aralkyl).

By “functionalized” as in “functionalized hydrocarbyl,” “functionalized alkyl,” “functionalized olefin,” “functionalized cyclic olefin,” and the like, is meant that in the hydrocarbyl, alkyl, olefin, cyclic olefin, or other moiety, at least one H atom bound to a carbon (or other) atom is replaced with one or more functional group(s) such as those described hereinabove. The term “functional group” is meant to include any functional species that is suitable for the uses described herein. In some cases, the terms “substituent” and “functional group” are used interchangeably.

“Optional” or “optionally” means that the subsequently described circumstance may or may not occur, so that the description includes instances where the circumstance occurs and instances where it does not. For example, the phrase “optionally substituted” means that a non-hydrogen substituent may or may not be present on a given atom, and, thus, the description includes structures wherein a non-hydrogen substituent is present and structures wherein a non-hydrogen substituent is not present.

The term “nil” means absent or nonexistent.

The term “sulfhydryl” represents a group of formula “—SH.”

The term “hydroxyl” represents a group of formula “—OH.”

The term “carbonyl” represents a group of formula “—C(O)—.”

The term “ketone” represents an organic compound having a carbonyl group linked to a carbon atom such as —C(O)R^{x}, wherein R^{x} can be alkyl, aryl, cycloalkyl, cycloalkenyl, or heterocycle as defined above.

The term “ester” represents an organic compound having a carbonyl group linked to a carbon atom such as —C(O)OR^{x} wherein R^{x} can be alkyl, aryl, cycloalkyl, cycloalkenyl, or heterocycle as defined above.

The term “amine” represents a group of formula “—NR^{x}R^{y},” wherein R^{x} and R^{y} can be the same or independently H, alkyl, aryl, cycloalkyl, cycloalkenyl, or heterocycle as defined above.

The term “carboxyl” represents a group of formula “—C(O)O—.”

The term “sulfonyl” represents a group of formula “—SO₂—.”

The term “sulfate” represents a group of formula “—O—S(O)₂—O—.”

The term “sulfonate” represents a group of the formula “—S(O)₂—O—.”

The term “amide” represents a group of formula “—C(O)NR^{x}R^{y},” wherein R^{x} and R^{y} can be the same or independently H, alkyl, aryl, cycloalkyl, cycloalkenyl, or heterocycle as defined above.

The term “sulfonamide” represents a group of formula “—S(O)₂NR^{x}R^{y}” wherein R^{x} and R can be the same or independently H, alkyl, aryl, cycloalkyl, cycloalkenyl, or heterocycle as defined above.

The term “sulfoxide” represents a group of formula “—S(O)—.”

The term “phosphonic acid” represents a group of formula “—P(O)(OH)₂.”

The term “phosphoric acid” represents a group of formula “—OP(O)(OH)₂.”

The term “sulphonic acid” represents a group of formula “—S(O)₂OH.”

The formula “H” represents a hydrogen atom.

The formula “O” represents an oxygen atom.

The formula “N” represents a nitrogen atom.

The formula “S” represents a sulfur atom.

Functional groups may be protected in cases where the functional group interferes with the metal carbene olefin metathesis catalyst, and any of the protecting groups commonly used in the art may be employed. Acceptable protecting groups may be found, for example, in Greene et al., Protective Groups in Organic Synthesis, 5th Ed. (New York: Wiley, 2014). Examples of protecting groups include acetals, cyclic acetals, boronate esters (boronates), cyclic boronate esters (cyclic boronates), carbonates, or the like. Examples of protecting groups include cyclic acetals or cyclic boronate esters.

### Monomers of the Invention

In one embodiment, the monomers of the invention have the structure of Formula (I):

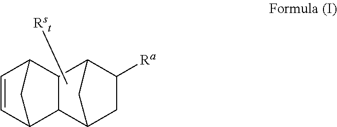

wherein:

R^{a} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, —CN, —NO₂, —CF₃, —P(O)(OH)₂, —OP(O)(OH)₂, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₈ cycloalkenyl, —CH₂-(optionally substituted C₃₋₈ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;

each R^{s} is independently optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, —CN, NO₂, —CF₃, —P(O)(OH)₂, —OP(O)(OH)₂, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₈ cycloalkenyl, —CH₂-(optionally substituted C₃₋₈ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;

t is 0, 1, 2, 3, 4, 5, or 6;

R^{f} is OH, OR^{k}, NR^{g}R^{h}, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{g} is H, optionally substituted linear or branched C₁₋₂₄ alkyl, optionally substituted C₃₋₁₀ cycloalkyl, optionally substituted heterocycle, optionally substituted C₅₋₂₄ aryl, optionally substituted linear or branched C₂₋₆ alkenyl, —C(O)-(optionally substituted C₅₋₂₄ aryl), —C(O)-(optionally substituted linear or branched C₂₋₆ alkenyl), or optionally substituted C₃₋₈ cycloalkenyl;

R^{h} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

Rⁱ is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{j} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{k} is optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{l} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{m} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

Rⁿ is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{o} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl; and

R^{p} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl.

In one embodiment, the monomers of the invention have the structure of Formula (I) wherein:

R^{a} is H, optionally substituted linear or branched C₁₋₁₂ alkyl, optionally substituted linear or branched C₂₋₁₂ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₇ cycloalkenyl, —CH₂-(optionally substituted C₅₋₇ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;

each R^{s} is independently optionally substituted linear or branched C₁₋₁₂ alkyl, optionally substituted linear or branched C₂₋₁₂ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₇ cycloalkenyl, —CH₂-(optionally substituted C₅₋₇ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;

t is 0, 1, 2, 3, or 4;

R^{f} is OH, OR^{k}, NR^{g}R^{h}, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

R^{g} is H, optionally substituted linear or branched C₁₋₁₂ alkyl, optionally substituted C₅₋₇ cycloalkyl, optionally substituted heterocycle, optionally substituted C₆₋₁₀ aryl, optionally substituted linear or branched C₂₋₆ alkenyl, —C(O)-(optionally substituted C₆₋₁₀ aryl), —C(O)-(optionally substituted linear or branched C₂₋₆ alkenyl), or optionally substituted C₅₋₇ cycloalkenyl;

R^{h} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

Rⁱ is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

R^{j} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

R^{k} is optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

R^{l} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

R^{m} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

Rⁿ is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

R^{o} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl; and

R^{p} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl.

In one embodiment, the monomers of the invention have the structure of Formula (I) wherein:

R^{a} is H, optionally substituted linear or branched C₁₋₆ alkyl, optionally substituted linear or branched C₂₋₆ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₇ cycloalkenyl, or —CH₂-(optionally substituted C₅₋₇ cycloalkenyl);

t is 0;

R^{f} is OH, OR^{k}, NR^{g}R^{h}, optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₇ cycloalkenyl;

R^{g} is H, optionally substituted linear or branched C₁₋₆ alkyl, optionally substituted C₅₋₇ cycloalkyl, optionally substituted heterocycle, optionally substituted C₆₋₁₀ aryl, optionally substituted linear or branched C₂₋₆ alkenyl, —C(O)-(optionally substituted C₆₋₁₀ aryl), —C(O)-(optionally substituted linear or branched C₂₋₆ alkenyl), or optionally substituted C₅₋₇ cycloalkenyl; and

R^{h} is H, optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₇ cycloalkenyl; and

R^{k} is optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₇ cycloalkenyl.

In one embodiment, the monomers of the invention have the structure of Formula (I) wherein: R^{a} is;

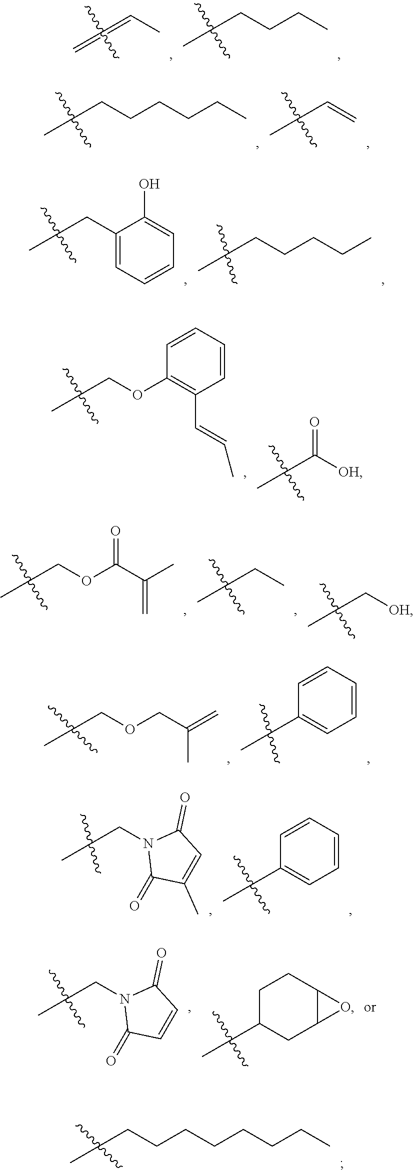

and t=0.

Non-limiting examples of monomers of Formula (I) include:

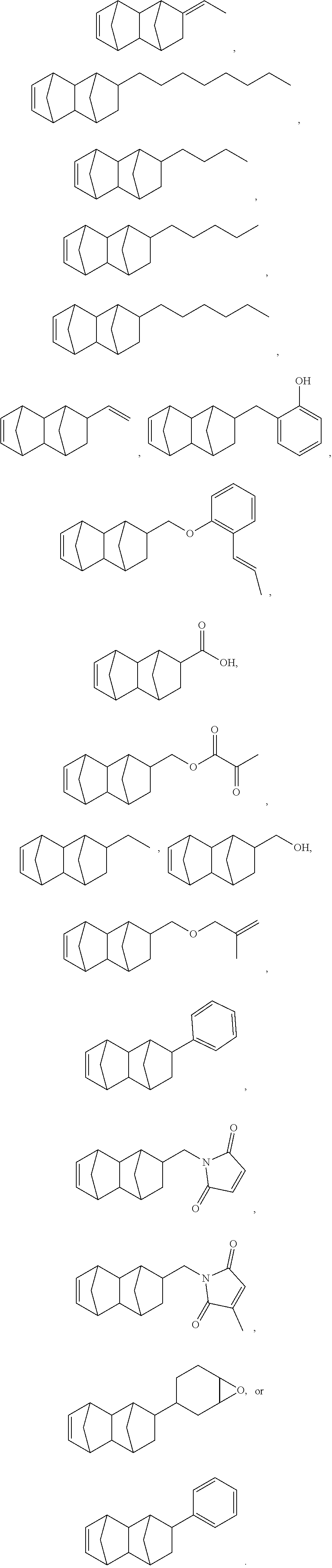

In one embodiment, the monomers of the invention have the structure of Formula (II):

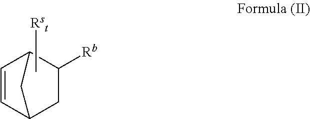

wherein:

R^{b} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, spiro optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₁₀ cycloalkenyl, —CH₂-(optionally substituted C₃₋₈ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;

each R^{s} is independently optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₈ cycloalkenyl, —CH₂-(optionally substituted C₃₋₈ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;

t is 0, 1, 2, 3, 4, 5, or 6;

R^{f} is OH, OR^{k}, NR^{g}R^{h}, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{g} is H, optionally substituted linear or branched C₁₋₂₄ alkyl, optionally substituted C₃₋₁₀ cycloalkyl, optionally substituted heterocycle, optionally substituted C₅₋₂₄ aryl, optionally substituted linear or branched C₂₋₆ alkenyl, —C(O)-(optionally substituted C₅₋₂₄ aryl), —C(O)-(optionally substituted linear or branched C₂₋₆ alkenyl), or optionally substituted C₃₋₈ cycloalkenyl;

R^{h} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

Rⁱ is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{j} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{k} is optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{l} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{m} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

Rⁿ is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{o} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl; and

R^{p} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl.

In one embodiment, the monomers of the invention have the structure of Formula (II):

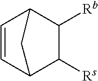

wherein: t=1 and R^{s} and R^{b} can form together an optionally substituted polycyclic structure.

In one embodiment, monomers of the invention have the structure of Formula (II) wherein:

R^{b} is H, optionally substituted linear or branched C₁₋₁₂ alkyl, optionally substituted linear or branched C₂₋₁₂ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, spiro optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₇ cycloalkenyl, —CH₂-(optionally substituted C₅₋₇ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;

each R^{s} is independently optionally substituted linear or branched C₁₋₁₂ alkyl, optionally substituted linear or branched C₂₋₁₂ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₇ cycloalkenyl, —CH₂-(optionally substituted C₅₋₇ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;

t is 0, 1, 2, 3, or 4;

R^{f} is OH, OR^{k}, NR^{g}R^{h}, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

R^{g} is H, optionally substituted linear or branched C₁₋₁₂ alkyl, optionally substituted C₅₋₇ cycloalkyl, optionally substituted heterocycle, optionally substituted C₆₋₁₀ aryl, optionally substituted linear or branched C₂₋₁₂ alkenyl, —C(O)-(optionally substituted C₆₋₁₀ aryl), —C(O)-(optionally substituted linear or branched C₂₋₁₂ alkenyl), or optionally substituted C₅₋₇ cycloalkenyl;

R^{h} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

Rⁱ is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

R^{j} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

R^{k} is optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

R^{l} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

R^{m} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

Rⁿ is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

R^{o} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl; and

R^{p} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl.

In one embodiment, the monomers of the invention have the structure of Formula (II) wherein:

R^{b} is H, optionally substituted linear or branched C₁₋₆ alkyl, optionally substituted linear or branched C₂₋₆ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, spiro optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₇ cycloalkenyl, or —CH₂-(optionally substituted C₅₋₇ cycloalkenyl);

t is 0;

R^{f} is OH, OR^{k}, NR^{g}R^{h}, optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₇ cycloalkenyl;

R^{g} is H, optionally substituted linear or branched C₁₋₆ alkyl, optionally substituted C₅₋₇ cycloalkyl, optionally substituted heterocycle, optionally substituted C₆₋₁₀ aryl, optionally substituted linear or branched C₂₋₆ alkenyl, —C(O)-(optionally substituted C₆₋₁₀ aryl), —C(O)-(optionally substituted linear or branched C₂₋₆ alkenyl), or optionally substituted C₅₋₇ cycloalkenyl;

R^{h} is H, optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₇ cycloalkenyl; and

R^{k} is optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₇ cycloalkenyl.

In one embodiment, the monomers of the invention have the structure of Formula (II) wherein:

### R^{b} is

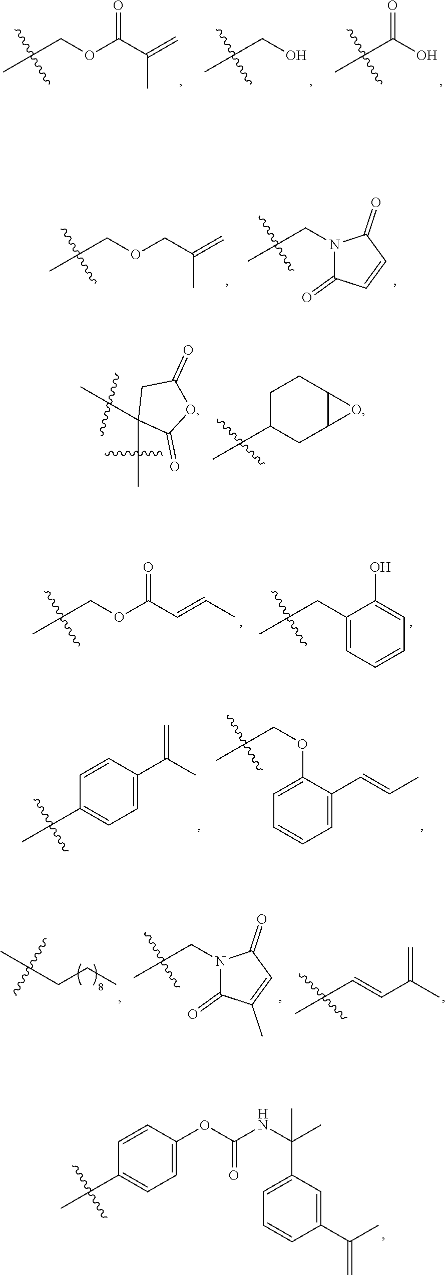

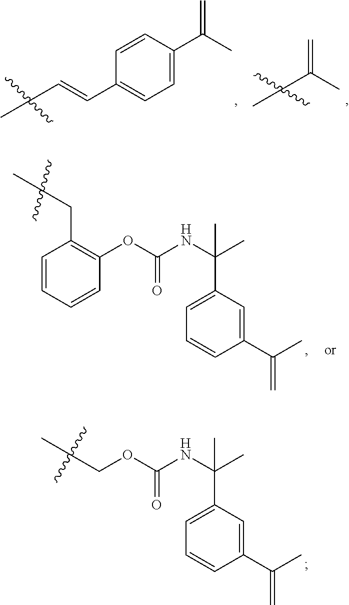

and t=0.

Non-limiting examples of monomers of Formula (II) include:

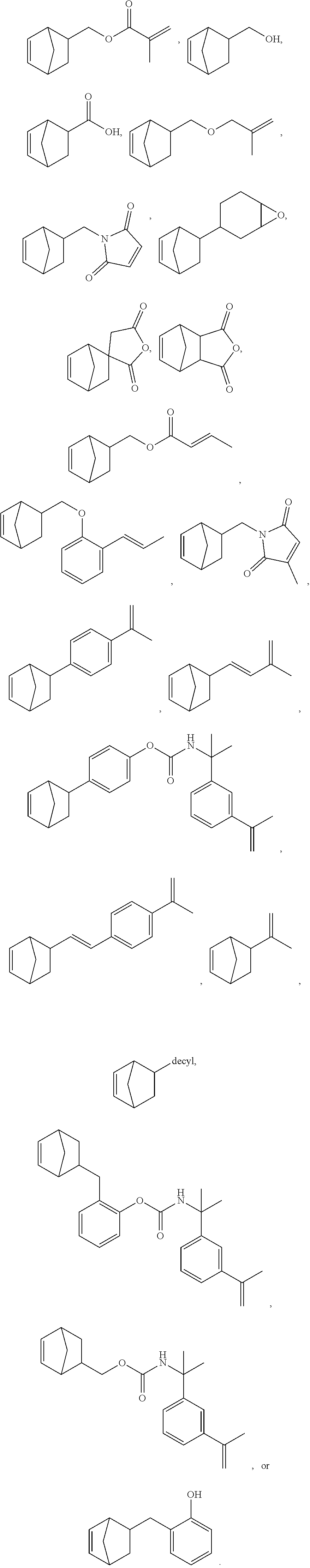

In one embodiment, monomers of the invention have the structure of Formula (III):

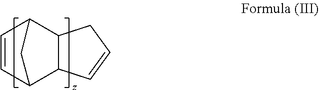

wherein z is 0, 1, 2, or 3.

In one embodiment, monomers of the invention have the structure of Formula (III), wherein z is 1 or 2.

In one embodiment, monomers of the invention have the structure of Formula (III), wherein z is 2.

Non-limiting examples of monomers of Formula (III) include:

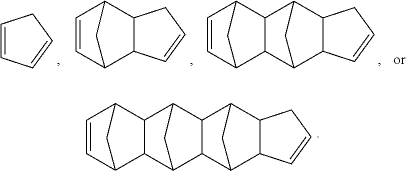

In one embodiment, the olefins of the invention have the structure of Formula (IV):

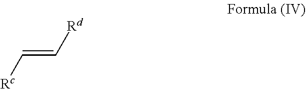

wherein:

R^{c} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₈ cycloalkenyl, —CH₂-(optionally substituted C₃₋₈ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;

R^{d} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₈ cycloalkenyl, —CH₂-(optionally substituted C₃₋₈ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;

R^{f} is OH, OR^{k}, NR^{g}R^{h}, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{g} is H, optionally substituted linear or branched C₁₋₂₄ alkyl, optionally substituted C₃₋₁₀ cycloalkyl, optionally substituted heterocycle, optionally substituted C₅₋₂₄ aryl, optionally substituted linear or branched C₂₋₆ alkenyl, —C(O)-(optionally substituted C₅₋₂₄ aryl), —C(O)-(optionally substituted linear or branched C₂₋₆ alkenyl), or optionally substituted C₃₋₈ cycloalkenyl;

R^{h} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

Rⁱ is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{j} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{k} is optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{l} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{m} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

Rⁿ is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{o} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl; and

R^{p} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl.

In one embodiment, the olefins of the invention have the structure of Formula (IV) wherein:

R^{c} is H, optionally substituted linear or branched C₁₋₁₂ alkyl, optionally substituted linear or branched C₂₋₁₂ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₇ cycloalkenyl, —CH₂-(optionally substituted C₅₋₇ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;

R^{d} is H, optionally substituted linear or branched C₁₋₁₂ alkyl, optionally substituted linear or branched C₂₋₁₂ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₇ cycloalkenyl, —CH₂-(optionally substituted C₅₋₇ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;

R^{f} is OH, OR^{k}, NR^{g}R^{h}, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

R^{g} is H, optionally substituted linear or branched C₁₋₁₂ alkyl, optionally substituted C₅₋₇ cycloalkyl, optionally substituted heterocycle, optionally substituted C₆₋₁₀ aryl, optionally substituted linear or branched C₂₋₆ alkenyl, —C(O)-(optionally substituted C₆₋₁₀ aryl), —C(O)-(optionally substituted linear or branched C₂₋₆ alkenyl), or optionally substituted C₅₋₇ cycloalkenyl;

R^{h} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

Rⁱ is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

R^{j} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

R^{k} is optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

R^{l} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

R^{m} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

Rⁿ is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl;

R^{o} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl; and

R^{p} is H, optionally substituted linear or branched C₁₋₁₂ alkyl, optionally substituted C₅₋₇ cycloalkyl, optionally substituted heterocycle, optionally substituted C₆₋₁₀ aryl, or optionally substituted C₅₋₇ cycloalkenyl.

In one embodiment, the olefins of the invention have the structure of Formula (IV) wherein:

R^{c} is H, optionally substituted linear or branched C₁₋₆ alkyl, optionally substituted linear or branched C₂₋₆ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₇ cycloalkenyl, or —CH₂-(optionally substituted C₅₋₇ cycloalkenyl);

R^{d} is H, optionally substituted linear or branched C₁₋₆ alkyl, optionally substituted linear or branched C₂₋₆ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₅₋₇ cycloalkenyl, or —CH₂-(optionally substituted C₅₋₇ cycloalkenyl);

R^{f} is OH, OR^{k}, NR^{g}R^{h}, optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₇ cycloalkenyl;

R^{g} is H, optionally substituted linear or branched C₁₋₆ alkyl, optionally substituted C₅₋₇ cycloalkyl, optionally substituted heterocycle, optionally substituted C₆₋₁₀ aryl, optionally substituted linear or branched C₂₋₆ alkenyl, —C(O)-(optionally substituted C₆₋₁₀ aryl), —C(O)-(optionally substituted linear or branched C₂₋₆ alkenyl), or optionally substituted C₅₋₇ cycloalkenyl;

R^{h} is H, optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₇ cycloalkenyl; and

R^{k} is optionally substituted linear or branched C₁₋₆ alkyl, optionally substituted C₅₋₇ cycloalkyl, optionally substituted heterocycle, optionally substituted C₆₋₁₀ aryl, or optionally substituted C₅₋₇ cycloalkenyl.

In one embodiment, the olefins of the invention have the structure of Formula (IV) wherein:

R^{c} is H,

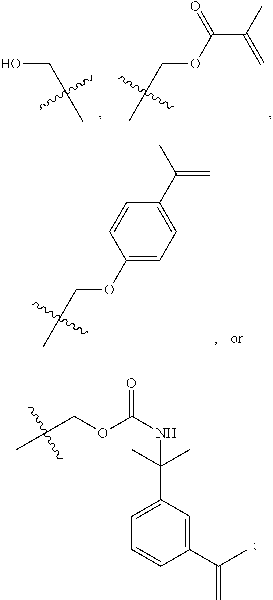

and

R^{d} is

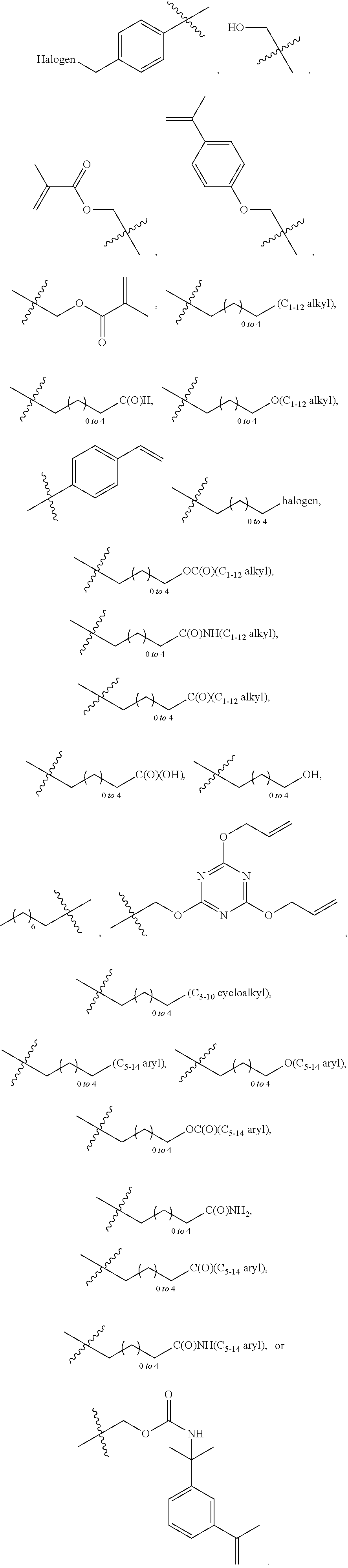

Non-limiting examples of Formula (IV) include:

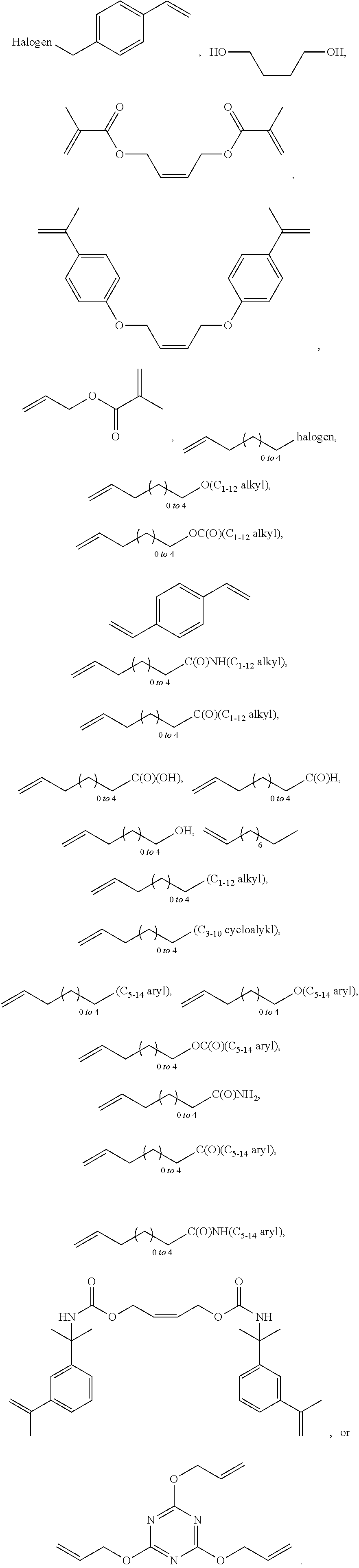

It is well understood by one of skill in the art that bicyclic and polycyclic olefins as disclosed herein may consist of a variety of structural isomers and/or stereoisomers, any and all of which are suitable for use in the invention. Any reference herein to such bicyclic and polycyclic olefins unless specifically stated includes mixtures of any and all such structural isomers and/or stereoisomers.

Examples of monomers thus include, without limitation, dicyclopentadiene; tricyclopentadiene, tetracyclopentadiene; norbornene; 5-methyl-2-norbornene; 5-ethyl-2-norbornene; 5-isobutyl-2-norbornene; 5,6-dimethyl-2-norbornene; 5-phenylnorbornene; 5-benzylnorbornene; 5-acetylnorbornene; 5-methoxycarbonylnorbornene; 5-ethoxycarbonyl-1-norbornene; 5-methyl-5-methoxy-carbonylnorbornene; 5-cyanonorbornene; 5,5,6-trimethyl-2-norbornene; cyclo-hexenylnorbornene; endo, exo-5,6-dimethoxynorbornene; endo, endo-5,6-dimethoxynorbornene; endo, exo-5-6-dimethoxycarbonylnorbomene; endo, endo-5,6-dimethoxycarbonylnorbomene; 2,3-dimethoxynorbornene; norbornadiene; tricycloundecene; tetracyclododecene; 8-methyltetracyclododecene; 8-ethyl-tetracyclododecene; 8-methoxycarbonyl tetracyclododecene; 8-methyl-8-tetracyclo-dodecene; 8-cyanotetracyclododecene; C₂-C₁₂ hydrocarbyl substituted norbornenes such as 5-butyl-2-norbornene; 5-hexyl-2-norbornene; 5-octyl-2-norbornene; 5-decyl-2-norbornene; 5-dodecyl-2-norbornene; 5-vinyl-2-norbornene; 5-ethylidene-2-norbornene; 5-isopropenyl-2-norbornene; 5-propenyl-2-norbornene; and 5-butenyl-2-norbornene, and the like; and C₂-C₁₂ hydrocarbyl substituted tetracyclododecene, such as 5-butyl-2-tetracyclododecene, 5-hexyl-2-tetracyclododecene, 5-octyl-2-tetracyclododecene, 5-decyl-2-tetracyclododecene, 5-dodecyl-2-tetracyclododecene, 5-vinyl-2-tetracyclododecene, 5-ethylidene-2-tetracyclododecene, 5-isopropenyl-2-tetracyclododecene, 5-propenyl-2-tetracyclododecene, and 5-butenyl-2-tetracyclododecene.

### Metal Carbene Olefin Metathesis Catalysts

The metal carbene olefin metathesis catalysts, suitable for the ring opening of the monomers of the invention, have the general structure of Formula (1):

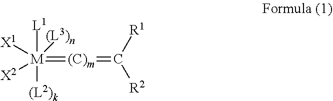

wherein:

M is a Group 8 transition metal; generally, M is ruthenium or osmium; typically, M is ruthenium;

L¹, L², and L³ are independently neutral electron donor ligands;

n is 0 or 1; typically, n is 0;

m is 0, 1, or 2; typically, m is 0;

k is 0 or 1; typically, k is 1;

X¹ and X² are independently anionic ligands; generally, X¹ and X² are independently halogen, trifluoroacetate, per-fluorophenols or together they can form a nitrate; typically, X¹ and X² are independently Cl, Br, I, or F; and

R¹ and R² are independently hydrogen, optionally substituted hydrocarbyl, optionally substituted heteroatom-containing hydrocarbyl; typically, R¹ is hydrogen and R² is optionally substituted phenyl, C₁-C₆ alkyl or substituted 1-propenyl; or R¹ and R² are linked together to form one or more cyclic groups, such as a substituted indenylidene, specifically 3-phenylindenylid-1-ene.

In one embodiment, the moiety

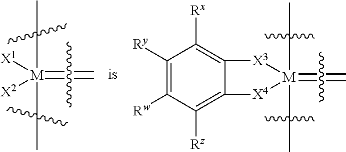

wherein:

X³ and X⁴ are independently O or S; typically, X³ and X⁴ are independently S; and

R^{x}, R^{y}, R^{w}, and R^{z} are independently hydrogen, halogen, optionally substituted hydrocarbyl, or optionally substituted heteroatom-containing hydrocarbyl; generally R^{x}, R^{y}, R^{w}, and R^{z} are independently hydrogen, halogen, optionally substituted C₁-C₁₂ alkyl, optionally substituted C₃-C₁₀ cycloalkyl, or optionally substituted C₅-C₂₄ aryl; typically, R^{x}, R^{y}, R^{w}, and R^{z} are independently C₁-C₆ alkyl, hydrogen, optionally substituted phenyl, or halogen; or R^{x} and R^{y} are linked together to form an optionally substituted bicyclic or polycyclic aryl; or R^{w} and R^{z} are linked together to form an optionally substituted bicyclic or polycyclic aryl; or R and R^{w} are linked together to form an optionally substituted bicyclic or polycyclic aryl.

In one embodiment, L¹ and L² are independently selected from phosphine, sulfonated phosphine, phosphite, phosphinite, phosphonite, arsine, stibine, ether, (including cyclic ethers), amine, amide, imine, sulfoxide, carboxyl, nitrosyl, pyridine, substituted pyridine, imidazole, substituted imidazole, pyrazine, substituted pyrazine and thioether. Exemplary ligands are trisubstituted phosphines. Preferred trisubstituted phosphines are of the formula PR^{H1}R^{H2}R^{H3} where R^{H1}, R^{H2}, and R^{H3} are each independently optionally substituted: C₆₋₁₀ aryl or C₁-C₁₀ alkyl, or C₃₋₁₀ cycloalkyl. In the most preferred, L¹ and L² are independently selected from the group consisting of trimethylphosphine (PMe₃), triethylphosphine (PEt₃), tri-n-butylphosphine (PBu₃), tri(ortho-tolyl)phosphine (P-o-tolyl₃), tri-tert-butylphosphine (P-tert-Bu₃), tricyclopentylphosphine (PCp₃), tricyclohexylphosphine (PCy₃), triisopropylphosphine (P-i-Pr₃), trioctylphosphine (POct₃), triisobutylphosphine, (P-i-Bu₃), triphenylphosphine (PPh₃), tri(pentafluorophenyl)phosphine (P(C₆F₅)₃), methyldiphenylphosphine (PMePh₂), dimethylphenylphosphine (PMe₂Ph), and diethylphenylphosphine (PEt₂Ph).

In one embodiment, L¹ is

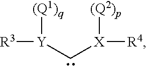

wherein X and Y are independently C, CR^{3a}, N, O, S, or P; only one of X or Y can be C or CR^{3a}; typically, X and Y are independently N; Q¹, Q², R³, R^{3a}, and R⁴ are independently hydrogen optionally substituted hydrocarbyl, optionally substituted heteroatom-containing hydrocarbyl; generally, Q¹, Q², R³, R^{3a}, and R⁴ are optionally linked to X or to Y via a linker such as optionally substituted hydrocarbylene, optionally substituted heteroatom-containing hydrocarbylene, or —(CO)—; typically Q¹, Q², R³, R^{3a}, and R⁴ are directly linked to X or to Y; and p is 0, when X is O or S, p is 1, when X is N, P, or CR^{3a}, and p is 2, when X is C; q is 0, when Y is O or S, q is 1, when Y is N, P, or CR^{3a}, and q is 2, when X is C.

In one embodiment, L¹ is

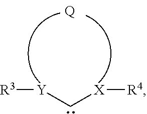

wherein Q is a two-atom linkage having the structure —[CR¹¹R¹²]ₛ—[CR¹³R¹⁴]ₜ— or —[CR¹¹═CR¹³]—; typically Q is —[CR¹¹R¹²]ₛ—[CR¹³R¹⁴]ₜ—, wherein R¹¹, R¹², R¹³, and R¹⁴ are independently hydrogen, optionally substituted hydrocarbyl, optionally substituted heteroatom-containing hydrocarbyl; typically R¹¹, R¹², R¹³, and R¹⁴ are independently hydrogen, optionally substituted C₁-C₁₂ alkyl, optionally substituted C₁-C₁₂ heteroalkyl, optionally substituted C₅-C₁₄ aryl;
“s” and “t” are independently 1 or 2; typically, “s” and “t” are independently 1; or any two of R¹¹, R¹², R¹³, and R¹⁴ are optionally linked together and can form an optionally substituted, saturated or unsaturated polycyclic ring structure.

In one embodiment, L¹ is

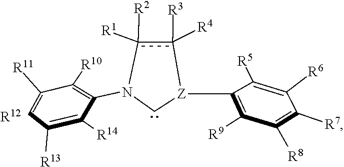

wherein Z is N or CR³²;

R¹ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R² can form a spiro compound, or together with R³ or together with R⁴ can form a polycyclic ring;

R² is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R¹ can form a spiro compound, or together with R³ or together with R⁴ can form a polycyclic ring;

R³ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R² or together with R¹ can form a polycyclic ring or together with R⁴ can form a spiro compound;

R⁴ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R³ can form a spiro compound, or together with R² or together with R¹ can form a polycyclic ring;

R⁵ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R⁶ can form an optionally substituted polycyclic ring;

R⁶ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R⁵ or together with R⁷ can form an optionally substituted polycyclic ring;

R⁷ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl optionally substituted C₃₋₈ cycloalkenyl, or together with R⁶ or together with R⁸ can form an optionally substituted polycyclic ring;

R⁸ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R⁷ or together with R⁹ can form an optionally substituted polycyclic ring;

R⁹ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R⁸ can form an optionally substituted polycyclic ring;

R¹⁰ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R¹¹ can form an optionally substituted polycyclic ring;

R¹¹ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R¹⁰ or together with R¹² can form an optionally substituted polycyclic ring;

R¹² is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R¹¹ or together with R¹³ can form an optionally substituted polycyclic ring;

R¹³ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R¹⁴ or together with R¹² can form an optionally substituted polycyclic ring;

R¹⁴ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R¹³ can form a polycyclic ring;

R³² is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R²⁵ is OH, OR³⁰, NR²⁷R²⁸, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R²⁶ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R²⁷ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R²⁸ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R²⁹ is H, optionally substituted C₁₋₂₄ alkyl, OR²⁶, —NR²⁷R²⁸, optionally substituted heterocycle, optionally substituted C₃₋₁₀ cycloalkyl, optionally substituted C₅₋₂₄ aryl, or optionally substituted C₃₋₈ cycloalkenyl;

R³⁰ is optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R³¹ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl; and x is 1 or 2.

In one embodiment, L² is

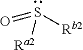

wherein:

R^{a2} is hydrogen, optionally substituted hydrocarbyl, or optionally substituted heteroatom-containing hydrocarbyl; generally R^{a2} is optionally substituted C₁-C₁₀ alkyl, optionally substituted C₃-C₁₀ cycloalkyl, or optionally substituted C₅-C₂₄ aryl; typically R^{a2} is methyl, ethyl, n-propyl, iso-propyl, n-butyl, tert-butyl, cyclohexyl, or phenyl; and

R^{b2} is hydrogen, optionally substituted hydrocarbyl, or optionally substituted heteroatom-containing hydrocarbyl; generally R^{b2} is optionally substituted C₁-C₁₀ alkyl, optionally substituted C₃-C₁₀ cycloalkyl, or optionally substituted C₅-C₂₄ aryl; typically R^{b2} is methyl, ethyl, n-propyl, iso-propyl, n-butyl, tert-butyl, cyclohexyl, or phenyl; or R^{a2} and R^{b2} are linked together to form a five or a six heterocyclic membered ring with the sulfoxide group [—S(O)—].

In one embodiment, L² is

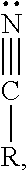

wherein: R is optionally substituted hydrocarbyl or optionally substituted heteroatom-containing hydrocarbyl; generally, R is optionally substituted C₁-C₁₀ alkyl, optionally substituted C₃-C₁₀ cycloalkyl, or optionally substituted C₅-C₂₄ aryl; typically, R is methyl, ethyl, n-propyl, iso-propyl, n-butyl, tert-butyl, or phenyl.

In one embodiment, L² is

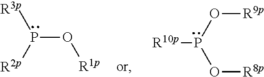

wherein: R^{1p}, R^{2p}, and R^{3p} are each independently optionally substituted C₆-C₁₀ aryl, optionally substituted C₁-C₁₀ alkyl, or optionally substituted C₃-C₁₀ cycloalkyl. R^{8p}, R^{9p}, and R^{10p} are each independently optionally substituted C₆-C₁₀ aryl, optionally substituted C₁-C₁₀ alkyl, or optionally substituted C₃-C₁₀ cycloalkyl.

In one embodiment, L² is

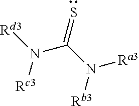

wherein:

R^{a3} is optionally substituted hydrocarbyl or optionally substituted heteroatom-containing hydrocarbyl; generally R^{a3} is optionally substituted C₁-C₁₀ alkyl, optionally substituted C₃-C₁₀ cycloalkyl, or optionally substituted C₅-C₂₄ aryl; typically R^{a3} is methyl, ethyl, n-propyl, iso-propyl, n-butyl, tert-butyl, cyclohexyl, benzyl, or phenyl;

R^{b3} is optionally substituted hydrocarbyl or optionally substituted heteroatom-containing hydrocarbyl; generally, R^{b3} is optionally substituted C₁-C₁₀ alkyl, optionally substituted C₃-C₁₀ cycloalkyl, or optionally substituted C₅-C₂₄ aryl; typically, R^{b3} is methyl, ethyl, n-propyl, iso-propyl, n-butyl, tert-butyl, cyclohexyl, benzyl, or phenyl; or R^{a3} and R^{b3} can be linked to form a five-, six-, or seven-membered heterocycle ring with the nitrogen atom they are linked to;

R^{c3} is optionally substituted hydrocarbyl or optionally substituted heteroatom-containing hydrocarbyl; generally, R^{c3} is optionally substituted C₁-C₁₀ alkyl, optionally substituted C₃-C₁₀ cycloalkyl, or optionally substituted C₅-C₂₄ aryl; typically, R^{c3} is methyl, ethyl, n-propyl, iso-propyl, n-butyl, tert-butyl, cyclohexyl, benzyl, or phenyl;

R^{d3} is optionally substituted hydrocarbyl or optionally substituted heteroatom-containing hydrocarbyl; generally, R^{d3} is optionally substituted C₁-C₁₀ alkyl, optionally substituted C₃-C₁₀ cycloalkyl, optionally substituted C₅-C₂₄ aryl; typically, R^{d3} is methyl, ethyl, n-propyl, iso-propyl, n-butyl, tert-butyl, cyclohexyl, benzyl, or phenyl; or R³ and R^{d3} can be linked to form a five-, six-, or seven-membered heterocycle ring with the nitrogen atom they are linked to; or R^{b3} and R^{c3} can be linked to form a five-, six-, or seven-membered heterocycle ring with the nitrogen atoms they are linked to.

In another embodiment, the metal carbene olefin metathesis catalysts suitable for the ring opening of the monomers of the invention have the general structure of Formula (2):

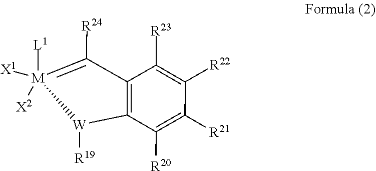

wherein:

L¹, X¹, and X² are as defined herein;

W is O, halogen, NR³³, or S;

R¹⁹ is H, optionally substituted C₁₋₂₄ alkyl, —C(R³⁴)(R³⁵)COOR³⁶, —C(R³⁴)(R³⁵)C(O)H, —C(R³⁴)(R³⁵)C(O)R³⁷, —C(R³⁴)(R³⁵)CR³⁸(OR³⁹)(OR⁴⁰), —C(R³⁴)(R³⁵)C(O)NR⁴¹R⁴², —C(R³⁴)(R³⁵)C(O)NR⁴¹OR⁴⁰, —C(O)R²⁵, optionally substituted heterocycle, optionally substituted C₃₋₁₀ cycloalkyl, optionally substituted C₅₋₂₄ aryl, optionally substituted C₃₋₈ cycloalkenyl, or when W is NR³³, then R¹⁹ together with R³³ can form an optionally substituted heterocyclic ring or when W is halogen then R¹⁹ is nil;

R²⁰ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R²¹ can form a polycyclic ring;

R²¹ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R²⁰ or together with R²² can form a polycyclic ring;

R²² is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R²¹ or together with R²³ can form a polycyclic ring;

R²³ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R²² can form a polycyclic ring;

R²⁴ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, or optionally substituted C₃₋₈ cycloalkenyl;

R²⁵ is OH, OR³⁰, NR²⁷R²⁸, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R²⁶ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R²⁷ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R²⁸ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R²⁹ is H, optionally substituted C₁₋₂₄ alkyl, OR²⁶, —NR²⁷R²⁸, optionally substituted heterocycle, optionally substituted C₃₋₁₀ cycloalkyl, optionally substituted C₅₋₂₄ aryl, or optionally substituted C₃₋₈ cycloalkenyl;

R³⁰ is optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R³¹ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R³³ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R³⁴ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R³⁵ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R³⁶ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R³⁷ is optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R³⁸ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R³⁹ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R⁴⁰ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R⁴¹ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R⁴² is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl; and

x is 1 or 2.

In some embodiments, the metal carbene olefin metathesis catalysts used in the invention have general structures:

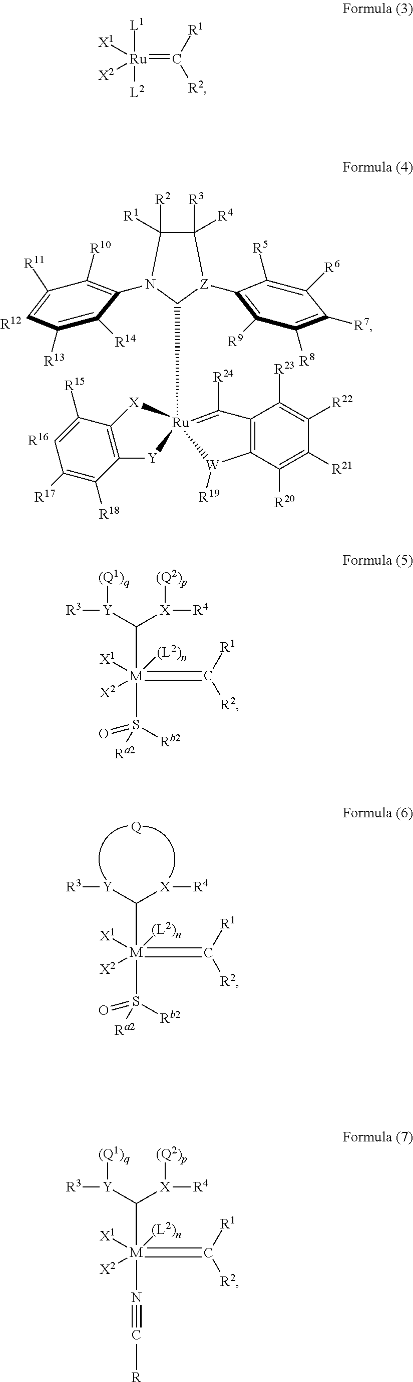

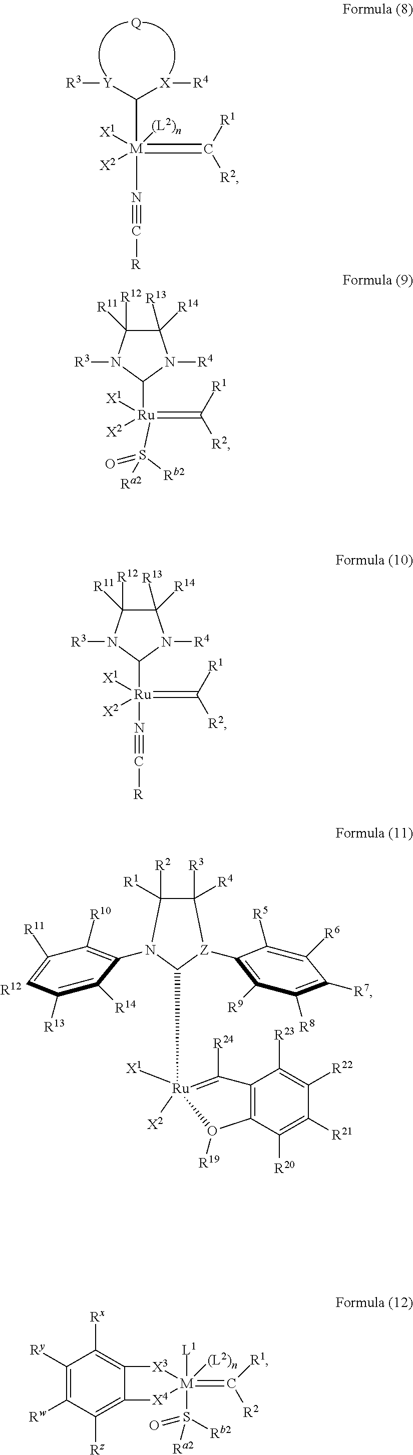

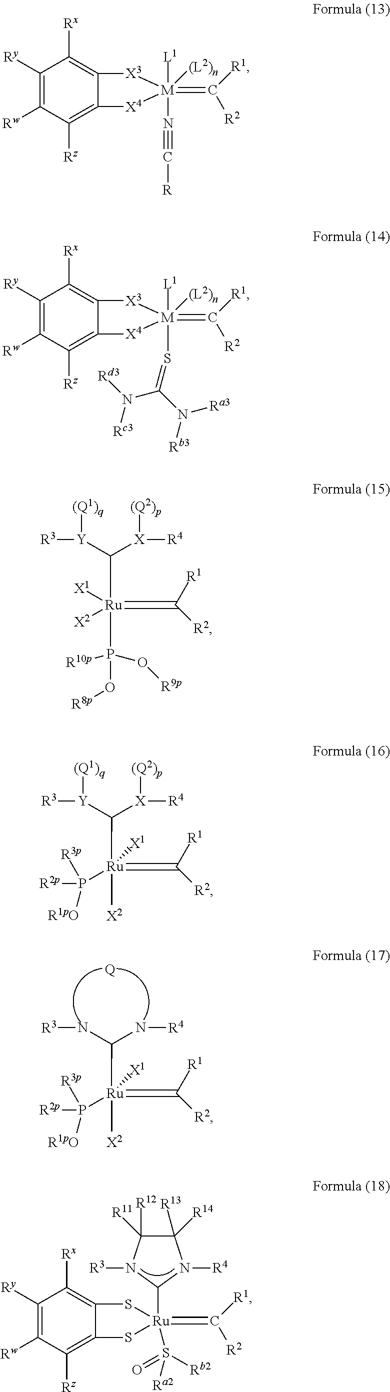

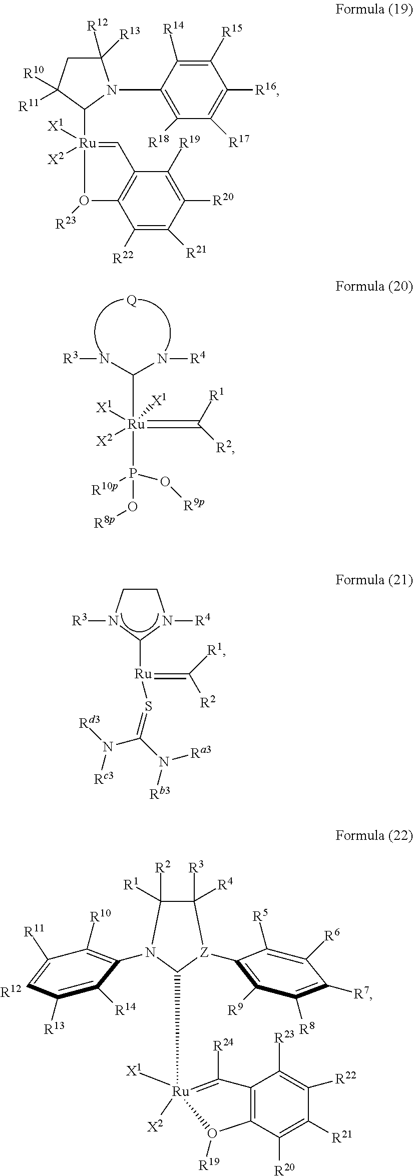

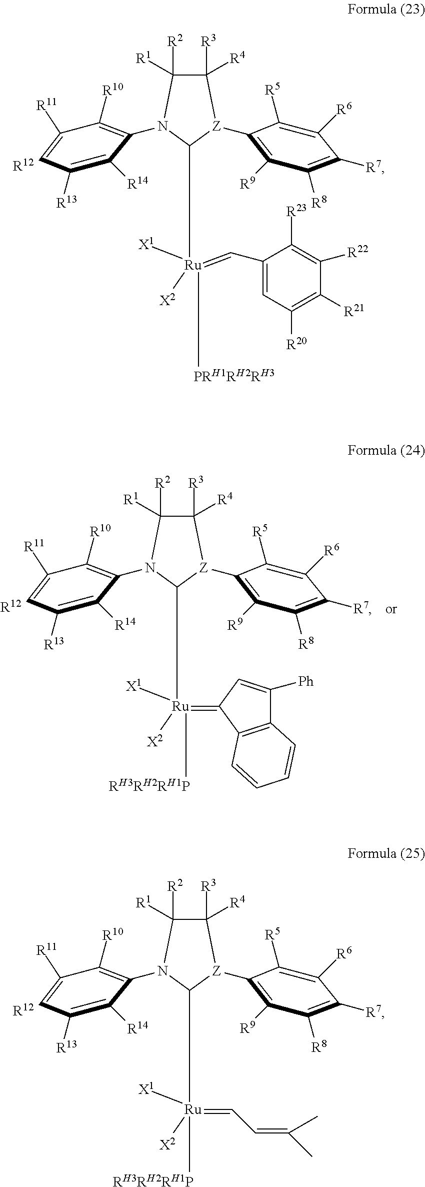

wherein Q, Q¹, Q², p, q, X¹, X², X³, X⁴, R, R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³, R²⁴, R²⁰, R²¹, R²², R²³, R²⁴, R^{a2}, R^{b2}, R^{a3}, R^{b3}, R^{c3}, R^{d3}, R^{1p}, R^{2p}, R^{3p}, R^{H1}, R^{H2}, R^{H3}, -(L²)ₙ-, and R⁴² are as defined herein.

Preferred metal carbene olefin metathesis catalysts used in the invention are encompassed by Formulae:

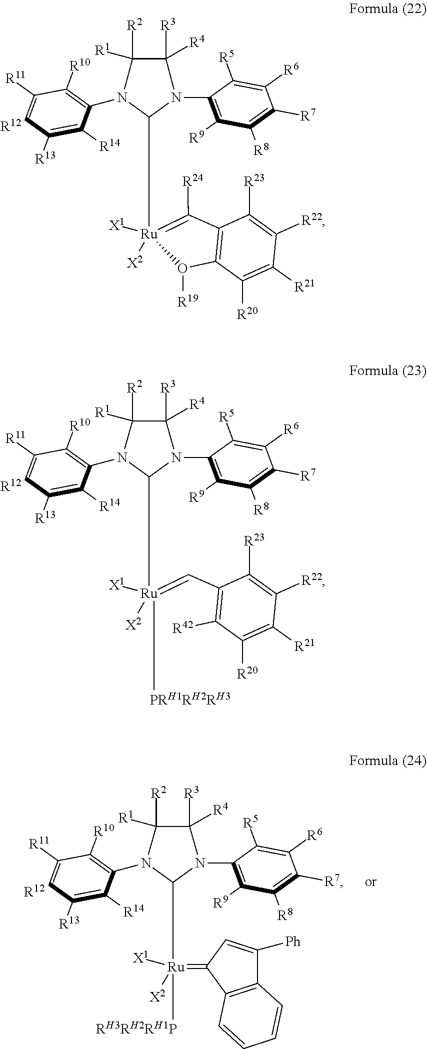

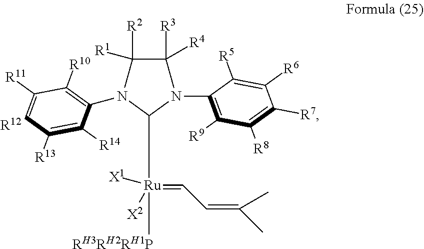

wherein X¹, X², R¹, R², R³, R⁴, R⁵, R⁶, R⁷, R⁸, R⁹, R¹⁰, R¹¹, R¹², R¹³, R¹⁴, R¹⁹, R²⁰, R²¹, R²², R²³, R²⁴, R^{H1}, R^{H2}, R^{H3}, and R⁴² are as defined herein.

Most preferred metal carbene olefin metathesis catalysts used in the invention are encompassed by Formulae:

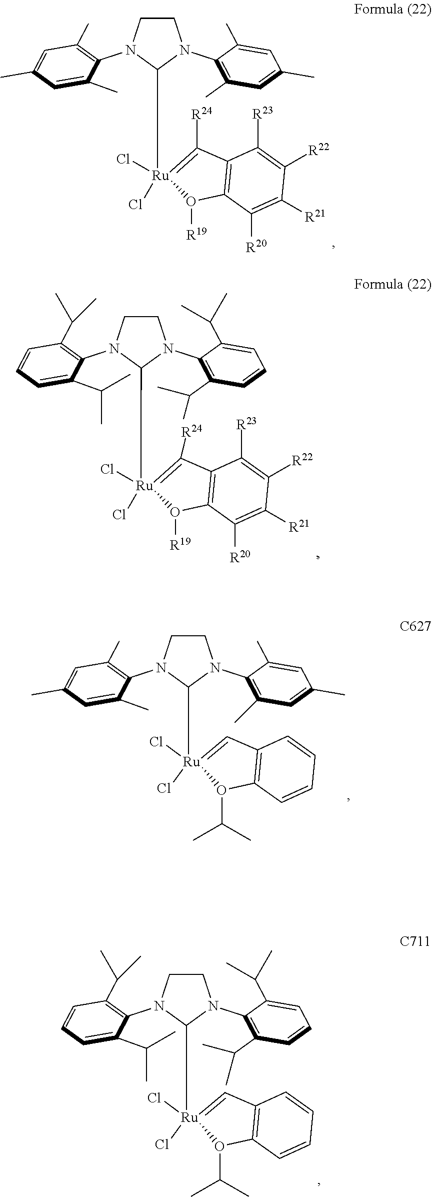

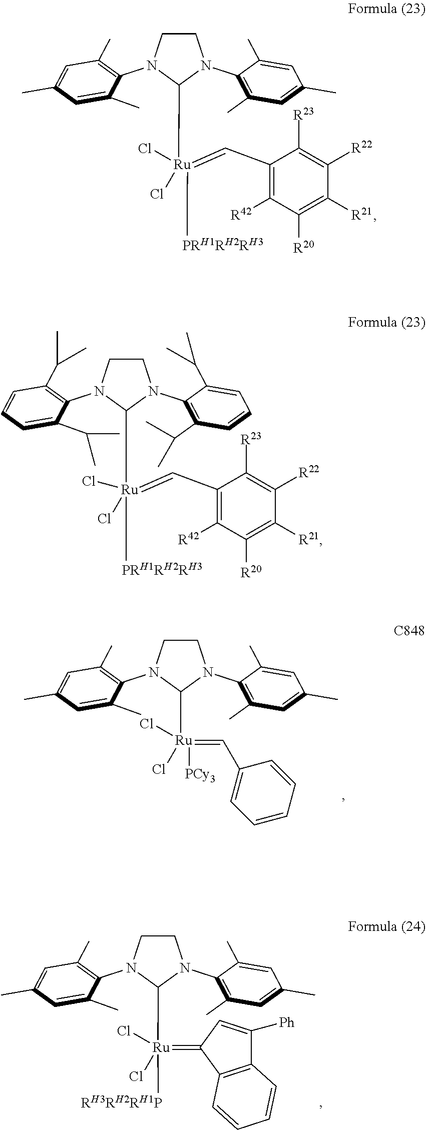

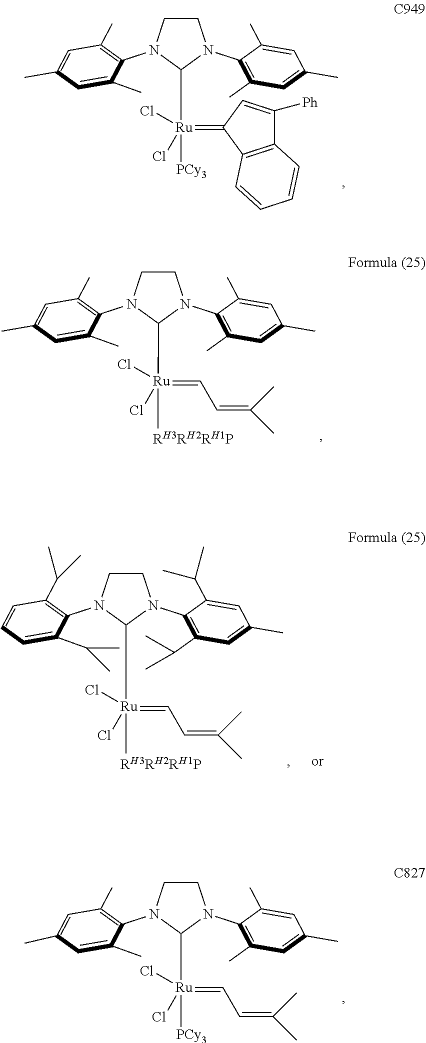

wherein: R¹⁹, R²⁰, R²¹, R²², R²³, R²⁴, Cy, R^{H1}, R^{H2}, R^{H3}, and R⁴² are as defined herein.

It will be appreciated that the amount of catalyst that is used (i.e., the “catalyst loading”) in the reaction is dependent upon a variety of factors such as the identity of the reactants and the reaction conditions that are employed. It is therefore understood that catalyst loading may be optimally and independently chosen for each reaction. In general, however, the catalyst will be present in an amount that ranges from a low of about 0.1 ppm, 1 ppm, or 5 ppm, to a high of about 10 ppm, 15 ppm, 25 ppm, 50 ppm, 100 ppm, 200 ppm, 500 ppm, or 1000 ppm relative to the amount of an olefinic substrate.

The catalyst will generally be present in an amount that ranges from a low of about 0.00001 mol %, 0.0001 mol %, or 0.0005 mol %, to a high of about 0.001 mol %, 0.0015 mol %, 0.0025 mol %, 0.005 mol %, 0.01 mol %, 0.02 mol %, 0.05 mol %, or 0.1 mol % relative to the olefinic substrate.

When expressed as the molar ratio of olefin to catalyst, the catalyst (the “olefin to catalyst ratio”), loading will generally be present in an amount that ranges from a low of about 10,000,000:1, 1,000,000:1, 500,000:1 or 200,00:1, to a high of about 100,000:1 60,000:1, 50,000:1, 45,000:1, 40,000:1, 30,000:1, 20,000:1, 10,000:1, 5,000:1, or 1,000:1.

### Embodiments of the Invention

The polymers of the invention can be synthesized according to synthetic Scheme 1, wherein at least one monomer of Formulae (I), (II), and (III), and optionally at least one olefin of Formula (IV) are submitted to ring opening metathesis reactions in the presence of at least one metal carbene olefin metathesis catalyst. The at least one metal carbene olefin metathesis catalyst can have the structure of Formula (1), Formula (2), or mixtures thereof.

In one embodiment, the invention provides a polymer having a dielectric constant Dₖ<3 at 1-100 GHz, and a dielectric loss D_{f}<0.01 at 1-100 GHz, synthesized by ring opening metathesis reactions comprising at least one monomer of Formulae (I), (II), and (III), optionally an olefin of Formula (IV), and at least one metal carbene olefin metathesis catalyst,

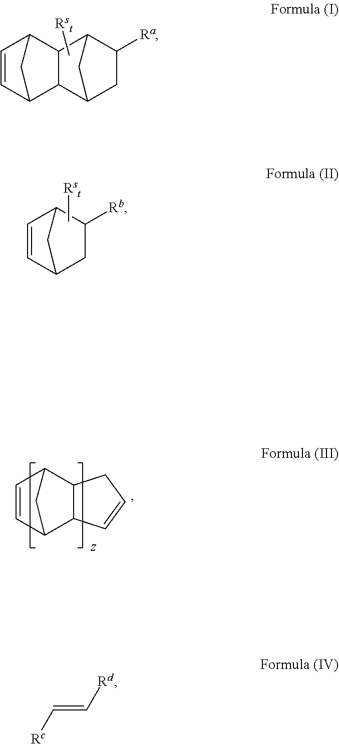

wherein:

z is 0, 1, 2 or 3;

R^{a} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, —CN, —NO₂, —CF₃, —P(O)(OH)₂, —OP(O)(OH)₂, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₈ cycloalkenyl, or —CH₂-(optionally substituted C₃₋₈ cycloalkenyl);

R^{b} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, —CN, —NO₂, —CF₃, —P(O)(OH)₂, —OP(O)(OH)₂, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₈ cycloalkenyl, or —CH₂-(optionally substituted C₃₋₈ cycloalkenyl);

R^{c} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₈ cycloalkenyl, —CH₂-(optionally substituted C₃₋₈ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;

R^{d} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₈ cycloalkenyl, —CH₂-(optionally substituted C₃₋₈ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;

each R^{s} is independently optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₈ cycloalkenyl, —CH₂-(optionally substituted C₃₋₈ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;

t is 0, 1, 2, 3, 4, 5, or 6;

R^{f} is OH, OR^{k}, NR^{g}R^{h}, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{g} is H, optionally substituted linear or branched C₁₋₂₄ alkyl, optionally substituted C₃₋₁₀ cycloalkyl, optionally substituted heterocycle, optionally substituted C₅₋₂₄ aryl, optionally substituted linear or branched C₂₋₆ alkenyl, —C(O)-(optionally substituted linear or branched C₂₋₆ alkenyl), or optionally substituted C₃₋₈ cycloalkenyl;

R^{h} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

Rⁱ is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{j} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{k} is optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{l} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{m} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

Rⁿ is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;

R^{o} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl; and

R^{p} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl.

In one embodiment, the polymers of the invention have Dₖ of 2.42, 2.44, 2.46, 2.47, 2.5 at 10 GHz and D_{f} of 0.017, 0.006, 0.004, 0.0033, 0.0008, 0.0009 at 10 GHz.

In one embodiment, the invention provides a polymer having a dielectric constant Dₖ<3 at 1-100 GHz, and a dielectric loss D_{f}<0.01 at 1-100 GHz, synthesized by ring opening metathesis reactions comprising at least one monomer of Formulae (I), (II), and (III), optionally an olefin of Formula (IV), and at least one metal carbene olefin metathesis catalyst,

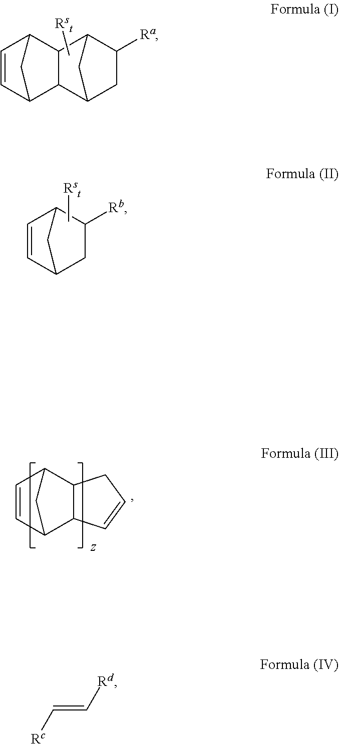

wherein:

z is 2;

t is 0;

R^{a} is optionally substituted linear or branched C₂₋₂₄ alkenyl, optionally substituted linear or branched C₁₋₂₄ alkyl, or optionally substituted C₅₋₂₄ aryl;

R^{b} is optionally substituted linear or branched C₁₋₂₄ alkyl, —CH₂—OR^{g}, —CH₂-(optionally substituted heterocycle), —C(O)R^{f}, optionally substituted heterocycle, spiro optionally substituted heterocycle, —CH₂-(optionally substituted C₅₋₂₄ aryl), or —CH₂—OR^{g};

R^{c} is H;

R^{d} is optionally substituted linear or branched C₁₋₂₄ alkyl, or —CH₂-(optionally substituted heterocycle);

R^{f} is OH; and

R^{g} is H, optionally substituted C₁₋₂₄ alkyl, —C(O)-(optionally substituted linear or branched C₂₋₆ alkenyl), or optionally substituted C₅₋₂₄ aryl.

In one embodiment, the invention provides a polymer having a dielectric constant Dₖ<3 at 1-100 GHz, and a dielectric loss D_{f}<0.01 at 1-100 GHz, synthesized by ring opening metathesis reactions comprising at least one monomer of Formulae (I), (II), and (III), optionally an olefin of Formula (IV), and at least one metal carbene olefin metathesis catalyst, wherein:

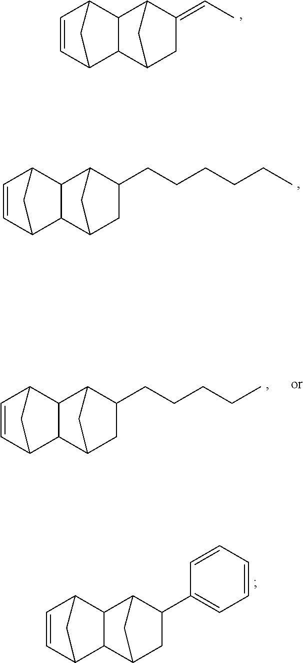

the at least one monomer of Formula (I) is

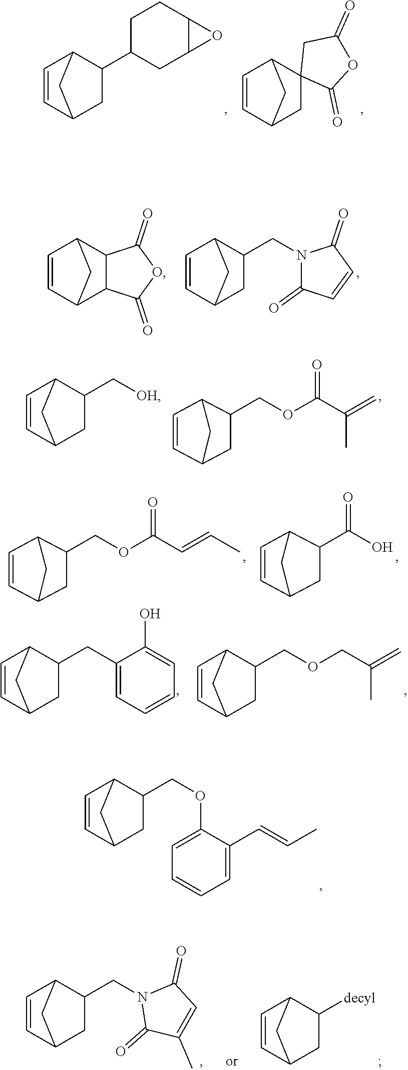

the at least one monomer of Formula (III) is

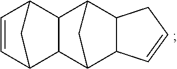 [SMILES: C1=CC2C(C1)C1CC2C2C3C=CC(C3)C12]

and the at least one olefin of Formula (IV) is

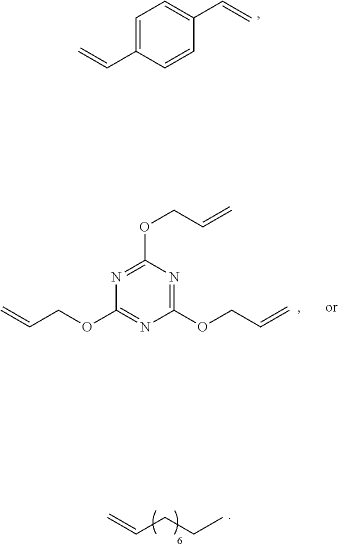

The expression “ring opening metathesis reactions comprising at least one monomer of Formulae (I), (II), and (III), optionally an olefin of Formula (IV)” means the following. The ring opening metathesis reactions comprise at least one of each monomers of Formulae (I), (II), and (III), and optionally at least one olefin of Formula (IV), or it means that the ring opening metathesis reactions comprise any combination of two or three of at least one monomer of Formulae (I), (II), or (III), and optionally an olefin of Formula (IV).

The polymers of the invention can be synthesized by ring opening metathesis reactions, comprising at least one monomer of Formulae (I), (II), and (III), optionally at least one olefin of Formula (IV), and at least one metal carbene olefin metathesis catalyst.

The polymers of the invention can also be synthesized by ring opening metathesis reactions, comprising at least one monomer of Formula (I), at least one monomer of Formula (II), and at least one metal carbene olefin metathesis catalyst.

The polymers of the invention can also be synthesized by ring opening metathesis reactions, comprising at least one monomer of Formula (I), at least one monomer of Formula (II), and at least one metal carbene olefin metathesis catalyst, wherein the at least one monomer of Formula (I) is

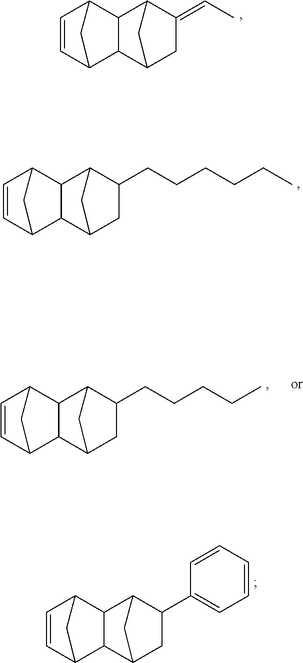

and the at least one monomer of Formula (II) is

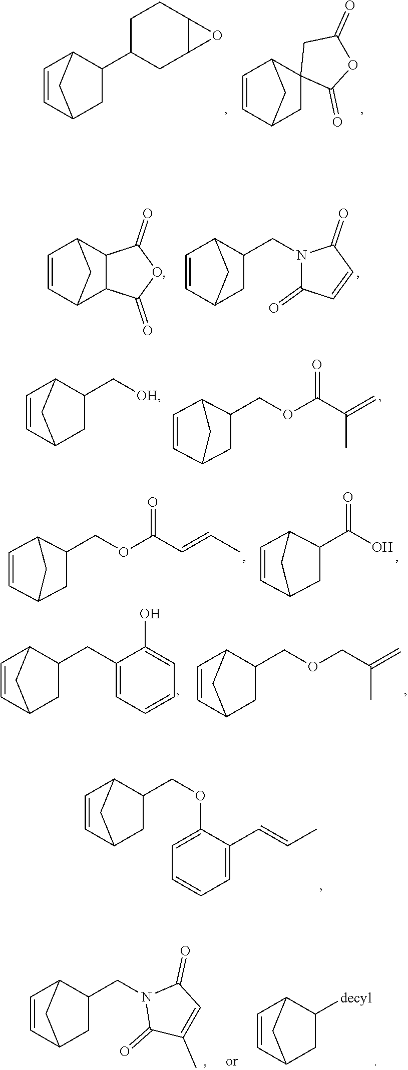

The polymers of the invention can also be synthesized by ring opening metathesis reactions, comprising at least one monomer of Formula (I), at least one monomer of Formula (II), optionally at least one olefin of Formula (IV), and at least one metal carbene olefin metathesis catalyst.

The polymers of the invention can also be synthesized by ring opening metathesis reactions, comprising at least one monomer of Formula (I), at least one monomer of Formula (II), optionally at least one olefin of Formula (IV), and at least one metal carbene olefin metathesis catalyst, wherein the at least one monomer of Formula (1) is

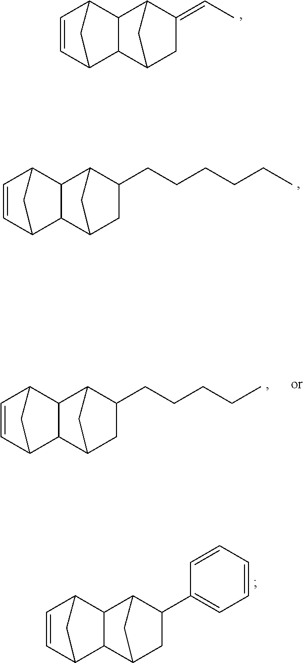

the at least one monomer of Formula (II) is

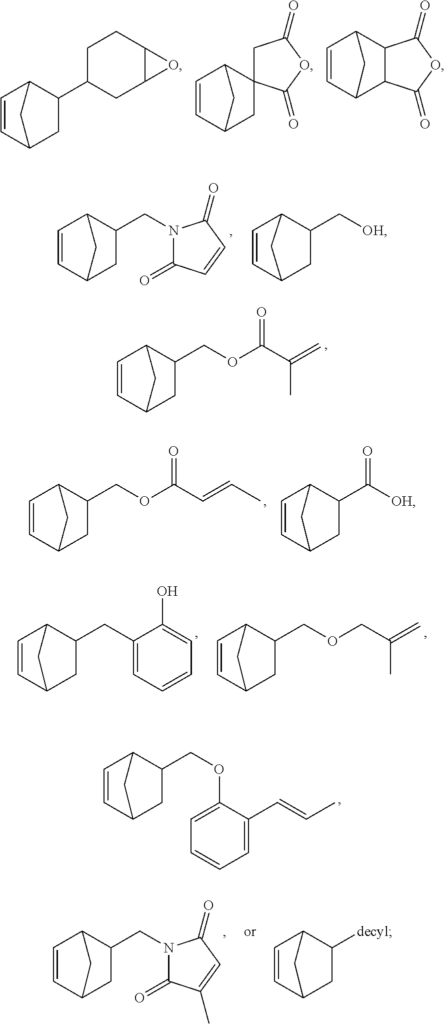

and the at least one monomer of Formula (IV) is

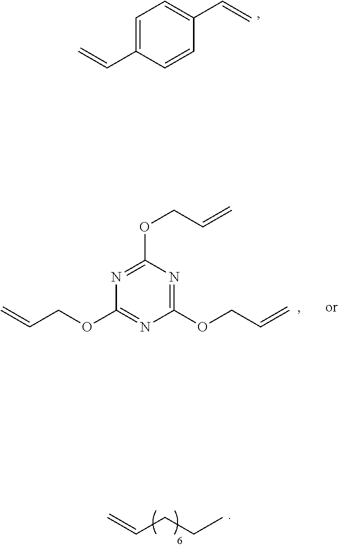

The polymers of the invention can also be synthesized by ring opening metathesis reactions, comprising at least one monomer of Formula (I), at least one monomer of Formula (II), at least one monomer of Formula (III), and at least one metal carbene olefin metathesis catalyst.

The polymers of the invention can also be synthesized by ring opening metathesis reactions, comprising at least one monomer of Formula (I), at least one monomer of Formula (II), at least one monomer of Formula (III), and at least one metal carbene olefin metathesis catalyst; wherein the at least one monomer of Formula (I) is

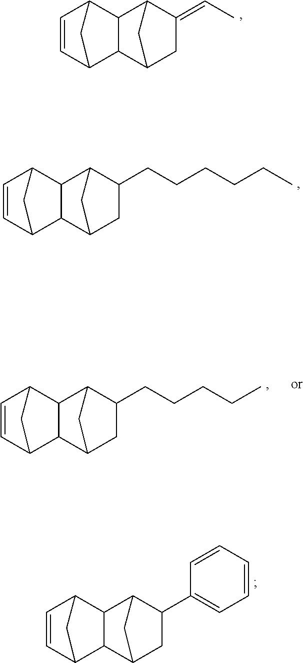

the at least one monomer of Formula (II) is

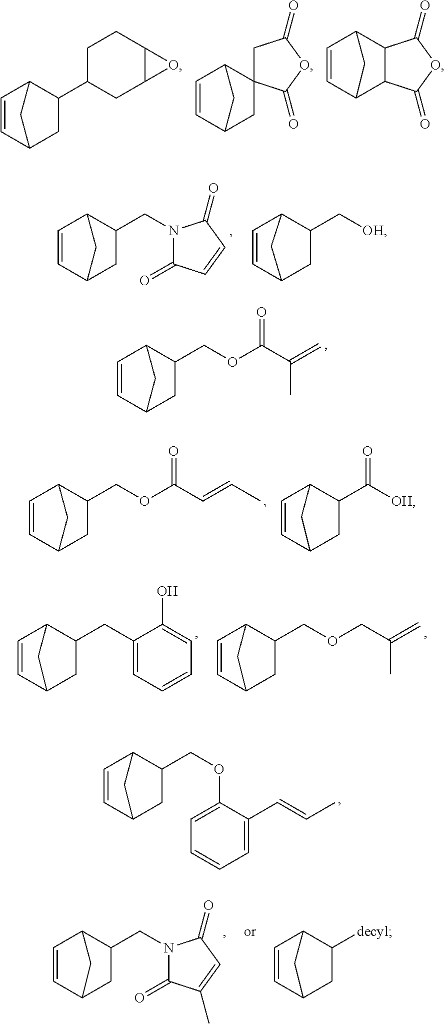

and the at least one monomer of Formula (III) is

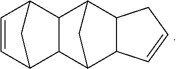 [SMILES: C1=CC2C(C1)C1CC2C2C3C=CC(C3)C12]

The polymers of the invention can also be synthesized by ring opening metathesis reactions, comprising at least one monomer of Formula (II), at least one monomer of Formula (III), optionally at least one olefin of Formula (IV), and at least one metal carbene olefin metathesis catalyst.

The polymers of the invention can also be synthesized by ring opening metathesis reactions, comprising at least one monomer of Formula (II), at least one monomer of Formula (III), optionally at least one olefin of Formula (IV), and at least one metal olefin metathesis catalyst, wherein:

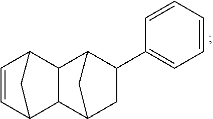 [SMILES: C1=CC2CC1C1C3CC(c4ccccc4)C(C3)C21]

the at least one monomer of Formula (II) is

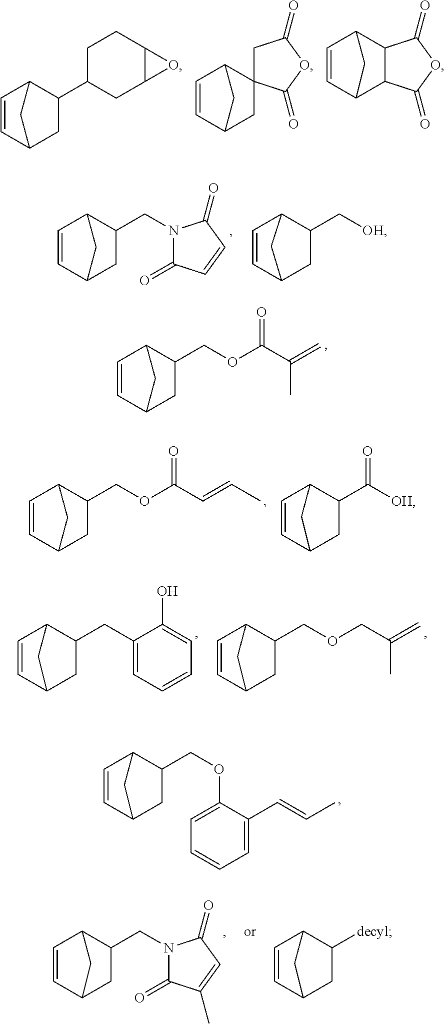

the at least one monomer of Formula (III) is

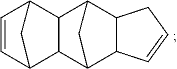 [SMILES: C1=CC2C(C1)C1CC2C2C3C=CC(C3)C12]

and the at least one olefin of Formula (IV) is

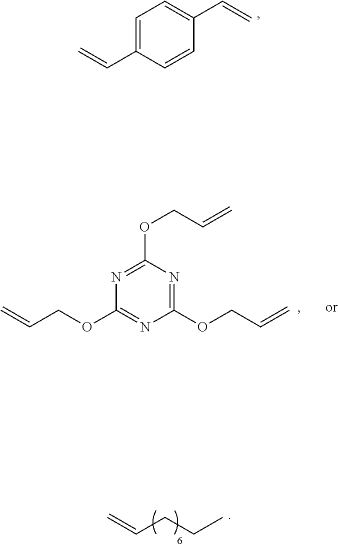

The polymers of the invention can also be synthesized by ring opening metathesis reactions, comprising at least one monomer of Formula (I), at least one monomer of Formula (III), and at least one metal carbene olefin metathesis catalyst.

The polymers of the invention can also be synthesized by ring opening metathesis reactions, comprising at least one monomer of Formula (I), at least one monomer of Formula (III), and at least one metal carbene olefin metathesis catalyst, wherein the at least one monomer of Formula (I) is

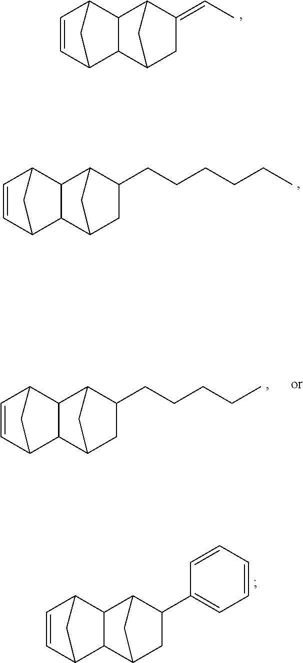

and the at least one monomer of Formula (III) is

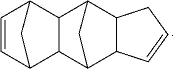 [SMILES: C1=CC2C(C1)C1CC2C2C3C=CC(C3)C12]

In one embodiment, the at least one metal carbene olefin metathesis catalyst can be any of the metal carbene olefin metathesis catalysts described herein, having the structure of Formulae (1), (2), (3), (4), (5), (6), (7), (8), (9), (10), (11), (12), (13), (14), (15), (16), (17), (18), (19), (20), (21), (22), (23), (24), or (25).

In one embodiment, the at least one metal carbene olefin metathesis catalyst has the structure of Formulae (22), (23), (24), or (25).

In one embodiment, the preferred at least one metal carbene olefin metathesis catalyst is a ruthenium olefin metathesis catalyst.

Formulae (1), (2), (3), (4), (5), (6), (7), (8), (9), (10), (11), (12), (13), (14), (15), (16), (17), (18), (19), (20), (21), (22), (23), (24), (25), (I), (II), (III), and (IV) are as defined herein.

The polymers of the invention can be further reacted with additives. These additives can be: antioxidants, peroxides, silica, flame retardants, reinforcing materials, light stabilizers, dyes, elastomers, fillers. Some additives such as antioxidants can be used to prevent thermal oxidation of the polymer; Lewis or Bronsted acids can be used to help with coordinating functional groups that slow polymerization reactions.

The polymers of the invention can also be crosslinked, for example, at elevated temperatures, and optionally in the presence of free-radical initiators, such organic peroxides, or other curative agents. such as diamines, triamines, polyamines, polycarboxylic acids, anhydrides and polyanhydrides, polythiols, and cationic initiators like Lewis acids

### Applications

One of skill in the art would appreciate that the polymers of the invention can be used in different types of applications such as: prepregs, fiber composite laminates, solvent based coatings, melt-extruded parts, films, and liquid compounds. Non-limiting examples of prepregs and laminates are: rigid printed circuit board, metal clad printed circuit boards, flexible printed circuit board, hybrid (e.g., rigid-flex) printed circuit board, thermal interface materials, IC substrate core, radomes, unidirectional carbon or glass fiber prepreg tapes, and electrical insulation composites. Non-limiting examples of films are: FPC adhesives, IC substrate build up layer, redistribution layer, die attach films, thermal interface materials, underfill, and encapsulation. Non-limiting examples of liquid compounds are: underfill, potting and encapsulations, die attach adhesives, photopatterning, mold compounds, wafer bonding, solder mask, thermal interface materials, conductive pastes, and inks. The polymers of the invention can be further hydrogenated to form polymer materials with low degree of unsaturated carbon-carbon bonds.

### EXPERIMENTAL

The following examples are for illustrative purposes only and are not intended, nor should they be construed as limiting the invention in any manner. Those skilled in the art will appreciate that variations and modifications of the following examples can be made without exceeding the spirit or scope of the invention.

Efforts have been made to ensure accuracy with respect to numbers used (e.g., amounts, temperature, etc.) but some experimental error and deviation should be accounted for. Unless indicated otherwise, temperature is in degrees Celsius (° C.), and pressure is at or near atmospheric.

All glassware was oven dried and reactions were performed under ambient conditions unless otherwise noted. All solvents and reagents were purchased from commercial suppliers and used as received unless otherwise noted.

The number average molecular weight (Mn) and the weight average molecular weight (Mw) of the polymers were determined by GPC/SEC. The polydispersity index, PDI=Mw/Mn was calculated. The gel permeation chromatography (GPC)/Size-exclusion chromatography (SEC) data were collected using two Agilent PLgel MIXED-B 300×7.5 mm columns with 10 m beads, connected to an Agilent 1260 Series pump, a Wyatt 18-angle DAWN HELEOS light scattering detector, and Optilab rEX differential refractive index detector. The mobile phase was THF and the flow rate was 1 mL/min.

Any metal carbene olefin metathesis catalysts described herein can be used in these examples. Some of the monomers were synthesized according to known literature procedures.

General GC method conditions: column: Agilent 122-5032E DB-5 (30 m×250 μm×0.25 μm), or equivalent. (5% Phenyl Methyl Siloxane). Injection temperature, 280° C.; detector temperature, 310° C.; oven temperature, starting temperature, 50° C.; hold time, 0.5 min. The ramp rate was 20° C./min to 210° C., ramp time was 5° C./min to 240° C., ramp time was 20° C./min to 280° C. hold time 2.5 min; Mode=Split 20.0:1.0; Split Flow=20.0 mL/min Pressure=12.05 psi; Total Flow=23.6 mL/min; constant flow carrier Gas=Helium @ 23.5 mL/min.

The FTIR (Fourier Transform infrared) analysis was determined on a Thermoscientific NicoletiS10 FTIR equipped with an ATR crystal using the Omnic 9 software; crystal type Diamond with ZnSe lens; pH range 1-14. The background was collected for the surface of the IR crystal (FTIR sensor) and then 50 mg of polymer powder was added to completely cover the crystal and the data collection took 32 scans.

The following abbreviations are used in the examples:

Mn [kDa] number average molecular weight in kilo Dalton
Mw [kDa] weight average molecular weight in kilo Dalton
PDI polydispersity index
Tg (° C.) glass transition temperature in degrees Celsius
IPA iso-propanol
MeOH methanol
TGA thermal gravimetric analysis
DMSO dimethylsulfoxide
NaOH sodium hydroxide
K₂CO₃ potassium carbonate
TBA.I tetrabutylammonium iodide
TBA.HSO₄ tetrabutylammonium hydrogen sulfate
TPP triphenylphosphine
BHT butylated hydroxytoluene
THE tetrahydrofuran
MEK methyl ethyl ketone
CDCl₃ deuterated chloroform
C₆D₆ deuterated benzene
DI Water deionized water
DCPD dicyclopentadiene
DCM dichloromethane
DSC differential scanning calorimetry

Non-limiting examples of monomers and reagents used in the synthesis of the polymers of the invention are shown in Table 1:

TABLE 1
Monomers and reagents

| Name | Structure | CAS number |
|---|---|---|
| 2-Propenoic acid, 2-methyl-, bicyclo[2.2.1]hept-5-en-2- ylmethyl ester | 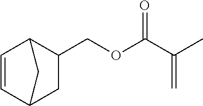 | 36578-43-5 |
| 1H-Pyrrole-2,5-dione, 1- (bicyclo[2.2.1]hept-5-en-2- ylmethyl)- | 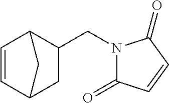 [SMILES: O=C1C=CC(=O)N1CC1CC2C=CC1C2] | 442665-16-9 |
| Spiro[bicyclo[2.2.1]hept-5- ene-2,3′(4′H)-furan]-2′,5′- dione | 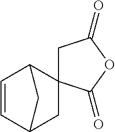 [SMILES: O=C1CC2(CC3C=CC2C3)C(=O)O1] | 58601-47-1 |
| 7-Oxabicyclo[4.1.0]heptane, 3-bicyclo[2.2.1]hept-5-en-2- yl- | 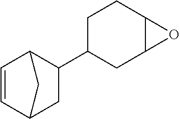 [SMILES: C1=CC2CC1CC2C1CCC2OC2C1] | 96534-93-9 |
| 4,7-Methanoisobenzofuran-1, 3-dione, 3a,4,7,7a-tetrahydro- | 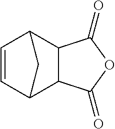 [SMILES: O=C1OC(=O)C2C3C=CC(C3)C12] | 826-62-0 |
| 4,7-Methano-1H-isoindole-1, 3(2H)-dione, 3a,4,7,7a- tetrahydro-2-(4- hydroxyphenyl)- | 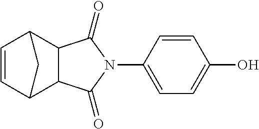 [SMILES: O=C1C2C3C=CC(C3)C2C(=O)N1c1ccc(O)cc1] | 10308-54-0 |
| 2-Butenoic acid, bicyclo[2.2.1]hept-5-en-2- ylmethyl ester | 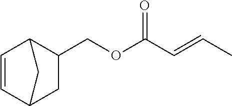 | 900185-05-9 |
| 1H-Pyrrole-2,5-dione, 1- (bicyclo[2.2.1]hept-5-en-2- ylmethyl)-3-methyl- | 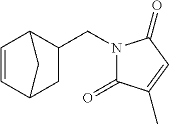 [SMILES: CC1=CC(=O)N(CC2CC3C=CC2C3)C1=O] | 1064312-51-1 |
| Phenol, 4-bicyclo[2.2.1]hept- 5-en-2-yl- | 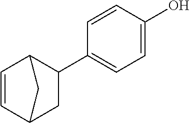 [SMILES: Oc1ccc(C2CC3C=CC2C3)cc1] | 239132-95-7 |
| Bicyclo[2.2.1]hept-5-ene-2- carboxylic acid | 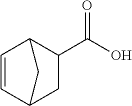 | 120-74-1 |
| Bicyclo[2.2.1]hept-5-ene-2- methanol, 2- methanesulfonate | 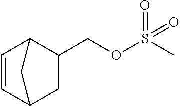 | 86646-41-5 |
| Phenol, 2-(1-propen-1-yl)- | 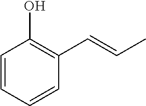 | 6380-21-8 |
| 2-Hydroxymethyl-5- norbornene | 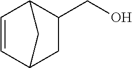 | 95-12-5 |
| Methallyl chloride 1-Propene, 3-chloro-2-methyl- | 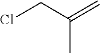 | 563-47-3 |
| Bicyclo[2.2.1]hept-5-ene-2- carboxylic acid, 2-ethylhexyl ester or Norbornene carboxylic acid 2-ethylhexyl ester | 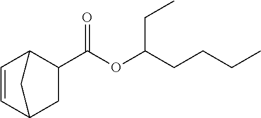 [SMILES: CCCCC(CC)OC(=O)C1CC2C=CC1C2] | 66063-67-0 |
| Ethylidenetetracyclododecene 1,4:5,8- Dimethanonaphthalene, 2- ethylidene-1,2,3,4,4a,5,8,8a- octahydro- | 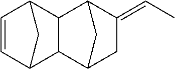 | 38233-76-0 |
| Tricyclopentadiene | 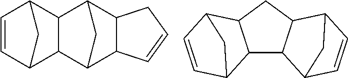 | 7158-25-0 |
| 1-octyne | 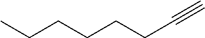 | 629-05-0 |
| 1-decene | 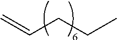 | 872-05-9 |
| Bicyclo[2.2.1]hept-2-ene, 5- ethyl- | 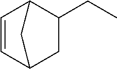 | 15403-89-1 |
| Bicyclo[2.2.1]hept-2-ene-5- (phenoxymethyl) | 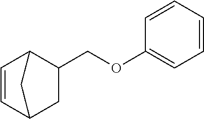 [SMILES: C1=CC2CC1CC2COc1ccccc1] | 75211-14-2 |
| 5-Phenyl-2-norbornene | 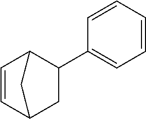 [SMILES: C1=CC2CC1CC2c1ccccc1] | 6143-30-2 |
| Bicyclo[2.2.1]hept-2-ene-5- (3-methylphenyl) | 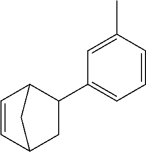 | 51690-56-3 |
| 1,4:5,8- Dimethanonaphthalene, 1,2,3, 4,4a,5,8,8a-octahydro-2- phenyl-(9CI) | 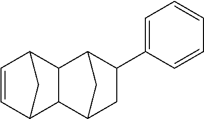 [SMILES: C1=CC2CC1C1C3CC(c4ccccc4)C(C3)C21] | 57467-58-0 |
| 1,4:5,8- Dimethanonaphthalene, 2- hexyl-1,2,3,4,4a,5,8,8a- octahydro | 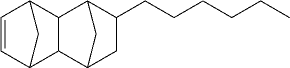 [SMILES: CCCCCCC1CC2CC1C1C3C=CC(C3)C21] | 344396-70-9 |
| 1,4:5,8- Dimethanonaphthalene, 2- butyl-1,2,3,4,4a,5,8,8a- octahydro | 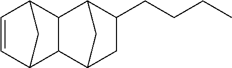 [SMILES: CCCCC1CC2CC1C1C3C=CC(C3)C21] | 1146980-03-1 |
| dicyclopentadiene | 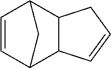 | 77-73-6 |
| Bicyclo[2.2.1]hept-2-ene, 5- ethylidene- | 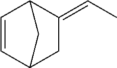 | 16219-75-3 |
| Divinylbenzene | 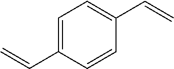 | 105-06-6 |
| Trivinylcyclohexane | 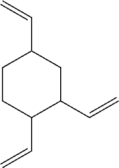 | 2855-27-8 |
| 2-Norbornyl acrylate | 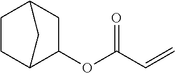 | 10027-06-2 |
| Glycidyl acrylate | 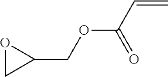 | 106-90-1 |
| Dicyclopentenyl acrylate | 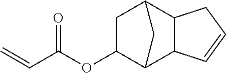 | 33791-58-1 |
| Divinyltetramethylsiloxane | 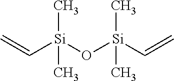 | 2627-95-4 |
| Allyl-2,4,6-tribromophenyl ether | 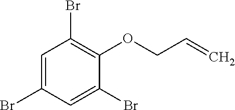 | 3278-89-5 |
| Di-tert butyl peroxide | 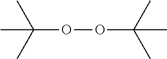 | 110-05-4 |
| Dicumyl peroxide | 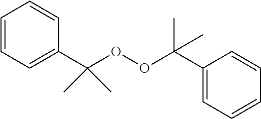 [SMILES: CC(C)(OOC(C)(C)c1ccccc1)c1ccccc1] | 80-43-3 |
| 2,4,6-tris(allyloxy)-s-triazine or TAC | 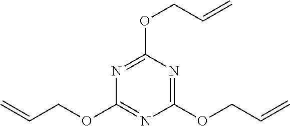 [SMILES: C=CCOc1nc(OCC=C)nc(OCC=C)n1] | 101-37-1 |

### Example 1

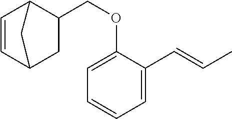 [SMILES: C/C=C/c1ccccc1OCC1CC2C=CC1C2]

### 5-((2-(prop-1-en-1-yl)phenoxy)methyl)bicyclo[2.2.1]hept-2-ene

A 1 L flask equipped with a magnetic stir bar was charged with bicyclo[2.2.1]hept-5-ene-2-methanol, 2-methanesulfonate [CAS 86646-41-5] (55 g, 271.91 mmol), 2-(1-propenyl) phenol [CAS 6380-21-8] (40 g, 298.12 mmol), potassium carbonate (10 g, 72.35 mmol), and DMSO (300 mL). The flask was placed under a nitrogen atmosphere and heated to 85° C. overnight. The reaction was cooled to room temperature and extracted with hexanes and washed with water (3 times, 500 mL each). The organic layer was washed with a 10% wt/wt solution of NaOH (200 mL) to remove excess phenol and then washed with water (200 mL). The organic layer was dried over sodium sulfate and filtered through a plug of silica gel. The solvent was removed by high vac resulting in 40.56 g of desired product. A mixture of endo and exo isomers was obtained.

¹H NMR (400 MHz, CDCl₃) δ 0.60-0.65 (m, 1H), 1.24-1.37 (m, 2H), 1.47 (d, J=8.0 Hz, 1H), 1.42 (dd, J=1.8 Hz, J=7.4 Hz, 3H), 1.89-1.93 (m, 1H), 2.55-2.63 (m, 1H), 2.84 (br s, 0.7H), 2.88 (br s, 0.3H), 3.05 (br s, 1H), 3.52 (t, J=9.2 Hz, 1H), 3.75 (dd, J=6.6 Hz, J=9.0 Hz, 1H), 3.86 (t, J=9.0 Hz, 0.3H), 4.05 (dd, J=6.2 Hz, J=9.2 Hz, 0.3H), 5.78-5.87 (m, 1H), 5.95 (dd, J=3.0 Hz, J=5.8 Hz, 0.7H), 6.10 (dd, J=3.0 Hz, J=5.8 Hz, 0.3H), 6.15 (dd, J=3.0 Hz, J=5.8 Hz, 1H), 6.60 (d, J=11.6 Hz, 1H), 6.82 (t, J=8.0 Hz, 1H), 6.91 (quint, J=6.9 Hz, 1H), 7.18 (t, J=8.0 Hz, 1H), 7.28 (d, J=7.2 Hz, 1H).

### Example 2

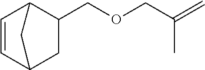

### 5-(((2-methylallyl)oxy)methyl)bicyclo[2.2.1]hept-2-ene

A 3-neck round bottom flask equipped with a magnetic stir bar was charged with an aqueous solution of NaOH (564 g, 50% wt/wt) and then diluted with ice (400 g). 2-Hydroxymethyl-5-norbornene [CAS 95-12-5] (300 g, 2.416 mol) was charged and stirring was established. TBA.I (120 g, 324.88 mmol) and TBA.HSO₄ (18 g, 53.01 mmol) were added and the biphasic mixture was heated to 55° C. Methallyl chloride (350 g, 3.865 mol) was added dropwise with an addition funnel over 1 h. The reaction was stirred overnight at 55° C. The mixture was cooled to room temperature and transferred to a separatory funnel. The aqueous layer was removed, and the organic layer was washed with DI water 3× (500 mL each). The organic layer was decanted into a container and dried over sodium sulfate. The mixture was transferred into a 1 L round bottom flask. The flask was equipped with a magnetic stir bar, a vigreux column, distillation bridge, and a condenser. The pot temperature was heated to 90° C., high vac=60 mTorr, and the cuts were monitored by GC. The distillation provided 320 g of desired product. A mixture of endo and exo isomers was obtained.

¹H NMR (400 MHz, C₆D₆) δ 0.40-0.45 (m, 1H), 0.99-1.04 (m, 0.2H), 1.07 (d, J=7.6 Hz, 0.8H), 1.14-1.22 (m, 0.4H), 1.32-1.34 (m, 0.2H), 1.42 (dd, J=2.0 Hz, J=8.4 Hz, 0.8H), 1.61-1.68 (m, 3H), 1.74-1.79 (m, 0.2H), 2.29-2.37 (m, 0.8H), 2.58 (br s, 0.8H), 2.62 (br s, 0.2H), 2.79 (br s, 0.2H), 2.94-2.96 (m, 1.2H), 3.03-3.06 (m, 0.8H), 3.12-3.17 (m, 0.2H), 3.25-3.29 (m, 0.2H) 3.66-3.75 (m, 2H), 4.83 (br s, 1H), 5.02 (br s, 1H), 5.90-5.95 (m, 1H), 5.96-6.03 (m, 1H).

### Example 3

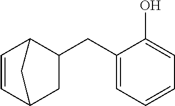 [SMILES: Oc1ccccc1CC1CC2C=CC1C2]

### 2-(bicyclo[2.2.1]hept-5-en-2-ylmethyl)phenol

A 2 L, 3-neck flask equipped with a magnetic stir bar, thermocouple well, and condenser was charged with DCPD (443 g, 3.351 mol) and 2-allylphenol [CAS 1745-81-9](449.63 g, 3.351 mol). The flask was placed under a nitrogen atmosphere and heated to an internal temperature of 170° C. for 2 d. The reaction was cooled to room temperature and then flask was equipped with a Vigreux column, distillation bridge, and a condenser. The pot temperature was gradually heated to 170° C., high vac=60 mTorr, and the cuts were monitored by GC. The distillation provided 67.11 g of desired product. A mixture of endo and exo isomers was obtained.

¹H NMR (400 MHz, CDCl₃) δ 0.63-0.67 (m, 1H), 1.19-1.37 (m, 2H), 1.55 (d, J=8.8 Hz, 0.5H), 1.78-1.86 (m, 1H), 2.05 (quint, J=2.1 Hz, 0.5H), 2.33-2.54 (m, 2H), 2.63-2.79 (m, 2H), 6.02 (br s, 0.5H), 6.09-6.11 (m, 0.75H), 6.17-6.20 (m, 0.75H), 6.73-6.78 (m, 1H), 6.81-6.84 (m, 1H), 6.97-7.03 (m, 1H), 7.06-7.12 (m, 1H), 8.10 (br s, 1H).

### Example 4

### General Procedure for the Synthesis of the Polymers of the Invention

A 3-neck, 1 L round bottom flask equipped with a thermocouple well and rare earth magnetic stir bar was charged with solvent (85% of the mass) and sparged with argon for 15 minutes. Non-limiting examples of solvents are: toluene, DCM, THF, cyclohexanone, and cyclopentanone. The metal carbene olefin metathesis catalyst was added to the flask and stirring was established at room temperature (23° C.). An addition funnel was charged with a solution of monomer(s) and olefin and optional solvent, which was then sparged with argon for 15 minutes and then slowly added to the stirring solution of catalyst. The monomer solution was added with a speed of 1 mL/min. In some cases, an internal temperature increase of a few degrees ° C., was observed, before returning to room temperature. The reaction was followed by GC, checking upon the consumption of the monomer. The reaction time took from a few hours to overnight.

Once the reaction was completed, the reaction mixture was diluted with a large quantity of an anti-solvent with vigorous stirring and an antioxidant was also added. The ratio solvent/anti-solvent is 1/6. Non-limiting examples of anti-solvents are: acetone, IPA, MeOH, hexanes, ethanol, heptanes, MEK, or mixtures thereof. A polymer suspension was formed which was stirred for 1 h and then filtered on a fritted funnel and washed with 500 mL of anti-solvent. The resulting polymer was dried in a vacuum oven under N₂: 2 hours at 25-30° C., 12 hours at 40-45° C. After cooling the oven to room temperature, the polymer powder was removed. TGA were ran to determine if the polymer was dry.

Polymers made according to the general procedure described in the experimental of Example 4, are listed in Table 2. The numbers under the structures represent the ratios in moles.

TABLE 2
Polymers of the invention

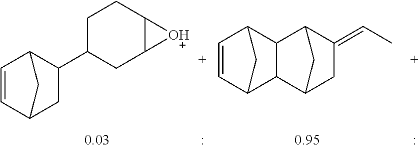

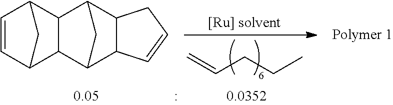

| | | |
|---|---|---|
| Polymer 1 | Mn [kDa] | 12.7 |
| | Mw [kDa] | 27.6 |
| | PDI | 2.166 |
| | Polymer Tg (° C.) | 199 |
| | IR [cm⁻¹] | 2917, 2323, 1522, 1448, 1002, 974, 806, |
| | | 739 |

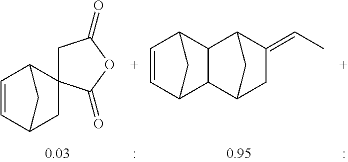

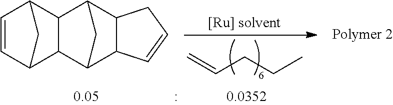

| | | |
|---|---|---|
| Polymer 2 | Mn [kDa] | 12.5 |
| | Mw [kDa] | 29.2 |
| | PDI | 2.329 |
| | Polymer Tg (° C.) | 184 |
| | IR [cm⁻¹] | 2956, 2917, 2359, 2343, 1790, 1473, |
| | | 974, 749 |

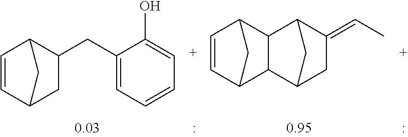

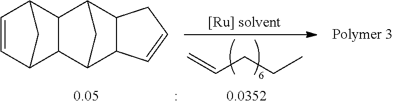

| | | |
|---|---|---|
| Polymer 3 | Mn [kDa] | 11.6 |
| | Mw [kDa] | 31.2 |
| | PDI | 2.774 |
| | Polymer Tg (° C.) | 189 |
| | IR [cm⁻¹] | 3649, 2960, 2918, 2869,2369, 1533, |
| | | 1465, 1395, 974, 805, 748 |

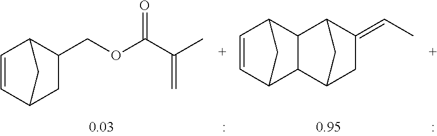

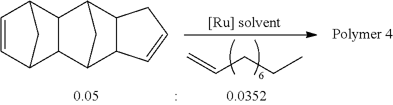

| | | |
|---|---|---|
| Polymer 4 | Mn [kDa] | 15.5 |
| | Mw [kDa] | 101.4 |
| | PDI | 6.53 |
| | Polymer Tg (° C.) | 99 |
| | IR [cm⁻¹] | 2959, 2912, 2361, 2343, 1698, 1540, |
| | | 1489, 1448, 973, 805, 748 |

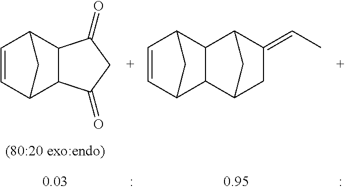

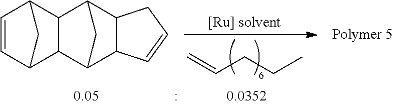

| | | |
|---|---|---|
| Polymer 5 | Mn [kDa] | 10.7 |
| | Mw [kDa] | 59.1 |
| | PDI | 5.522 |
| | Polymer Tg (° C.) | 179 |
| | IR [cm⁻¹] | 2956, 2917, 2359, 2343, 1790, 1473, |
| | | 974, 749 |

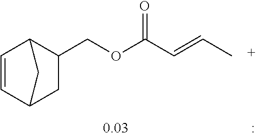

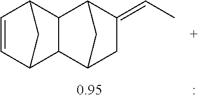

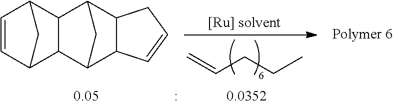

| | | |
|---|---|---|
| Polymer 6 | Mn [kDa] | 15.5 |
| | Mw [kDa] | 101.4 |
| | PDI | 6.530 |
| | Polymer Tg (° C.) | 185 |
| | IR [cm⁻¹] | 2959, 2912, 2361, 2343, 1698, 1540, |
| | | 1489, 1448, 973, 805, 748 |

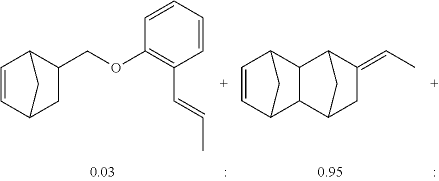

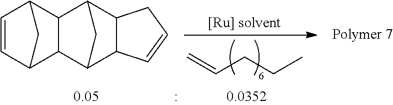

| | | |
|---|---|---|
| Polymer 7 | Mn [kDa] | 14.4 |
| | Mw [kDa] | 62.5 |
| | PDI | 4.338 |
| | Polymer Tg (° C.) | 188 |
| | IR [cm⁻¹] | 2918, 2359, 2343, 1697, 1507, 1436, |
| | | 1245, 975, 807, 752 |

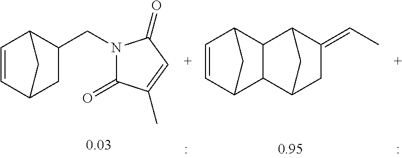

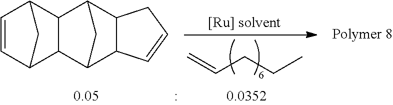

| | | |
|---|---|---|
| Polymer 8 | Mn [kDa] | 19.9 |
| | Mw [kDa] | 42.4 |
| | PDI | 2.126 |
| | Polymer Tg (° C.) | 103 |
| | IR [cm⁻¹] | 3859, 3656, 2959, 2912, 2360, 2343, |
| | | 2331, 1733, 1716, 1558, 1540, 1473, |
| | | 1457, 974, 805, 748 |

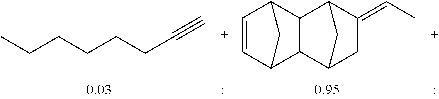

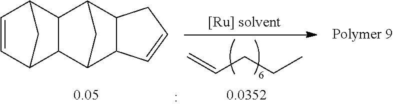

| | | |
|---|---|---|
| Polymer 9 | Mn [kDa] | 9.7 |
| | Mw [kDa] | 17 |
| | PDI | 1.752 |
| | Polymer Tg (° C.) | 94 |
| | IR [cm⁻¹] | 2957, 2918, 25359, 1473, 1457, 1448, |
| | | 974, 806, 748 |

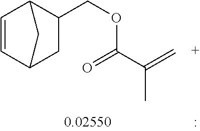

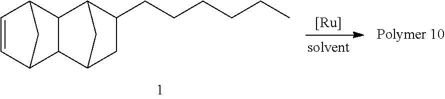 [SMILES: CCCCCCC1CC2CC1C1C3C=CC(C3)C21]

| | | |
|---|---|---|
| Polymer 10 | Mn [kDa] | 24.1 |
| | Mw [kDa] | 56 |
| | PDI | 2.329 |
| | Polymer Tg (° C.) | 101 |
| | IR [cm⁻¹] | 2921, 2853, 1717, 1540, 1457, 1339, |
| | | 973, 751, 725 |

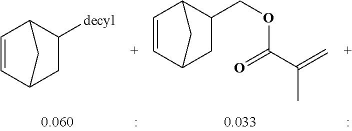

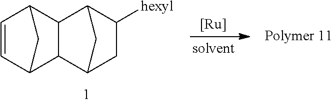

| | | |
|---|---|---|
| Polymer 11 | Mn [kDa] | 13.8 |
| | Mw [kDa] | 22.1 |
| | PDI | 1.608 |
| | Polymer Tg (° C.) | 68 |
| | IR [cm⁻¹] | 2921, 2851, 2359, 1718, 1457, 1158, |
| | | 987, 754, 722 |

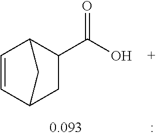

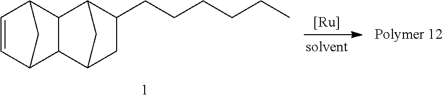 [SMILES: CCCCCCC1CC2CC1C1C3C=CC(C3)C21]

| | | |
|---|---|---|
| Polymer 12 | Mn [kDa] | 34.8 |
| | Mw [kDa] | 75.3 |
| | PDI | 2.162 |
| | Polymer Tg (° C.) | 80 |
| | IR [cm⁻¹] | 2920, 2854, 2360, 1704, 1456, 972, 751, |
| | | 724 |

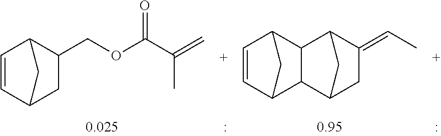

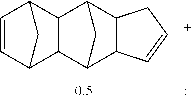 [SMILES: C1=CC2C(C1)C1CC2C2C3C=CC(C3)C12]

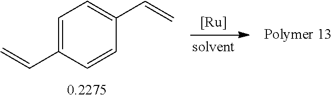

| | | |
|---|---|---|
| Polymer 13 | Mn [kDa] | 3.5 |
| | Mw [kDa] | 5.9 |
| | PDI | 1.68 |
| | Polymer Tg (° C.) | 88 |
| | IR [cm⁻¹] | 2958, 2917, 2162, 1718, 1477, 1448, |
| | | 1376, 974, 806, 749 |

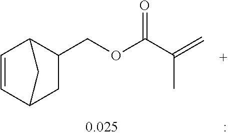

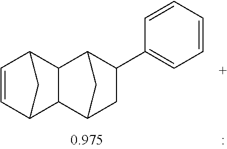 [SMILES: C1=CC2CC1C1C3CC(c4ccccc4)C(C3)C21]

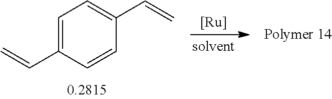

| | | |
|---|---|---|
| Polymer 14 | Mn [kDa] | 3.2 |
| | Mw [kDa] | 6 |
| | PDI | 1.87 |
| | Polymer Tg (° C.) | 110 |
| | IR [cm⁻¹] | 2934, 2871, 1717, 1495, 1480, 1447, |
| | | 1339, 1156, 973, 940, 785, 748 |

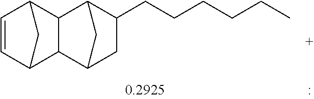 [SMILES: CCCCCCC1CC2CC1C1C3C=CC(C3)C21]

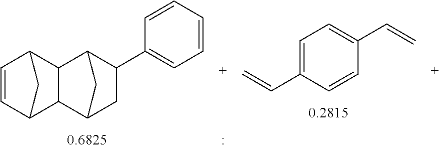

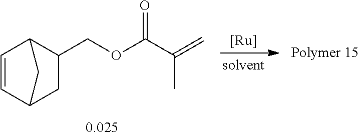

| | | |
|---|---|---|
| Polymer 15 | Mn [kDa] | 4.9 |
| | Mw [kDa] | 7.6 |
| | PDI | 1.54 |
| | Polymer Tg (° C.) | 109 |
| | IR [cm⁻¹] | 2928, 2869, 1717, 1495, 1480, 1457, |
| | | 1339, 1156, 973, 905, 785, 748, 697 |

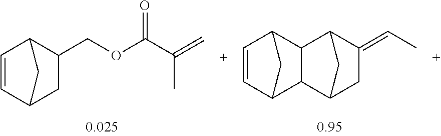

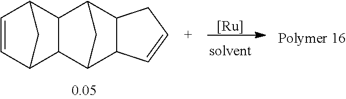 [SMILES: C1=CC2C(C1)C1CC2C2C3C=CC(C3)C12]

| | | |
|---|---|---|
| Polymer 16 | Mn [kDa] | 19.1 |
| | Mw [kDa] | 83.6 |
| | PDI | 4.368 |
| | Polymer Tg (° C.) | 204 |
| | IR [cm⁻¹] | 2919, 2359, 2162, 1717, 1474, 1448, |
| | | 974, 940, 805, 748, 697 |

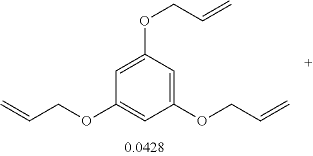 [SMILES: C=CCOc1cc(OCC=C)cc(OCC=C)c1]

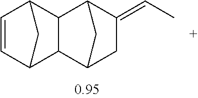

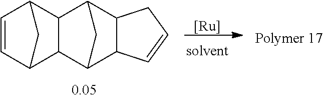 [SMILES: C1=CC2C(C1)C1CC2C2C3C=CC(C3)C12]

| | | |
|---|---|---|
| Polymer 17 | Mn [kDa] | 28.9 |
| | Mw [kDa] | 86.3 |
| | PDI | 2.984 |
| | Polymer Tg (° C.) | 110 |
| | IR [cm⁻¹] | 3735, 2958, 2916, 2360, 2162, 1992, |
| | | 1868, 1684, 1559, 1541, 1473, 1127, |
| | | 974, 806, 748 |

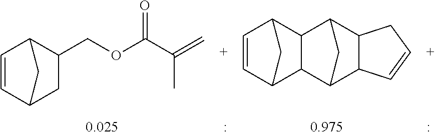

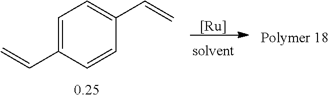

| | | |
|---|---|---|
| Polymer 18 | Mn [kDa] | 8.0 |
| | Mw [kDa] | 17.5 |
| | PDI | 2.2 |
| | Polymer Tg (° C.) | 106 |
| | IR [cm⁻¹] | 2941, 2871, 2360,1717, 1507, 1474, |
| | | 1457, 976, 941, 740, 699 |

### Example 5

### Preparation of Bulk Cast Polymers

Bulk cast polymers were prepared to enable the measurements of Dₖ/D_{f}. Molded parts were constructed between aluminum plates with ⅛″ thick cavity. Liquid monomer samples were prepared in ratios specified in reaction schemes. Additional additives such as antioxidant, inhibitor, and peroxide were added to the reaction mixture. The reaction mixture was then degassed under agitation at room temperature, catalyst was added and further degassed. The degassed catalyzed reaction mixture was poured into a room temperature mold and placed in a 40° C. pre-heated oven. After 10 minutes at 40° C. the oven temperature was increased to 225° C. and cured for 2 hours. The hardened parts were de-molded, test specimens were machined to desired geometries, and sent to CCN (Connected Community Networks, Inc.) for dielectric measurement. Thermal properties were measured internally via DSC. The data are presented in Table 3.

TABLE 3
Bulk cast samples data

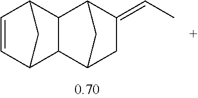

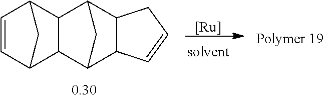 [SMILES: C1=CC2C(C1)C1CC2C2C3C=CC(C3)C12]

| | | |
|---|---|---|
| Polymer 19 | Polymer Tg (° C.) | 164 |
| | Dk @ 10 GHz | 2.46 |
| | Df @ 10 GHz | 0.0009 |

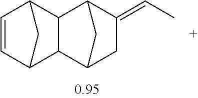

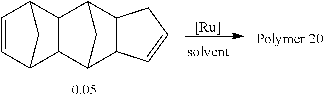 [SMILES: C1=CC2C(C1)C1CC2C2C3C=CC(C3)C12]

| | | |
|---|---|---|
| Polymer 20 | Polymer Tg (° C.) | 174 |
| | Dk @ 10 GHz | 2.42 |
| | Df @ 10 GHz | 0.001 |

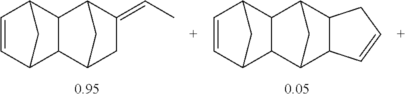

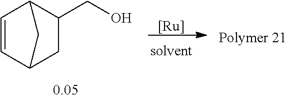

| | | |
|---|---|---|
| Polymer 21 | Polymer Tg (° C.) | 167 |
| | Dk @ 10 GHz | 2.5 |
| | Df @ 10 GHz | 0.004 |

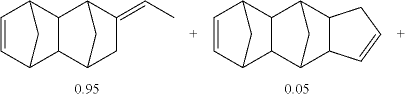

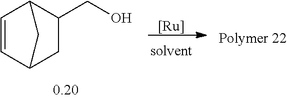

| | | |
|---|---|---|
| Polymer 22 | Polymer Tg (° C.) | 110 |
| | Dk @ 10 GHz | 2.64 |
| | Df @ 10 GHz | 0.017 |

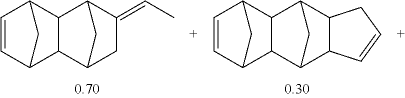

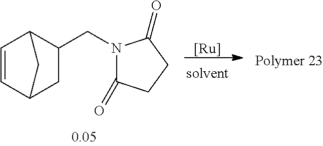 [SMILES: O=C1CCC(=O)N1CC1CC2C=CC1C2]

| | | |
|---|---|---|
| Polymer 23 | Polymer Tg (° C.) | 177 |
| | Dk @ 10 GHz | 2.47 |
| | Df @ 10 GHz | 0.0008 |

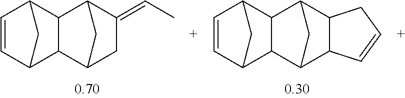

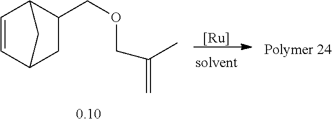

| | | |
|---|---|---|
| Polymer 24 | Polymer Tg (° C.) | 163 |
| | Dk @ 10 GHz | 2.4 |
| | Df @ 10 GHz | 0.0033 |

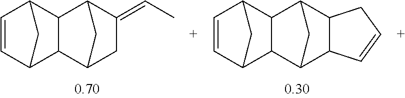

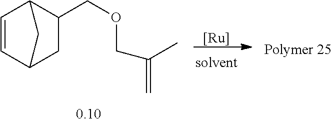

| | | |
|---|---|---|
| Polymer 25 | Polymer Tg (° C.) | 175 |
| | Dk @ 10 GHz | 2.44 |
| | Df @ 10 GHz | 0.006 |

### Example 6

### Procedure for the Synthesis of Polymer 26

A 3-neck, 12 L round bottom flask equipped with a thermocouple well and a rare earth magnetic stir bar was charged with isopropanol (7 L) which was then sparged with argon for 15 minutes. C627 (0.11 g) and Irganox (3.0 g) were added to the flask and the solution was continued to purge with argon for 5 minutes. In a 1 L Erlenmeyer flask, PhNB (300 g), DNB (61.960 g), and NB-MMA (33.876 g) were mixed and sparged with argon. The content was transferred to a 1 L addition funnel which was then connected to the flask. The system was evacuated and refilled with argon 3 times. The mixture in addition funnel was drop-wise added to the isopropanol solution. As the addition continued, white polymer solid precipitated out of solution. The addition took 3-4 hours. The final temperature in the flask reached 30° C. The solid was isolated by a fret funnel and washed with isopropanol. The solid was further dried in a vacuum oven at 30° C. for 16 hours. Yield: 328 g. The data are presented in Table 4.

TABLE 4
Polymer 26 of the invention

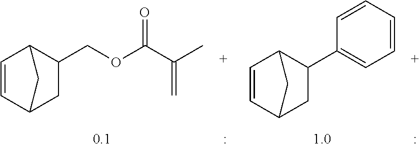

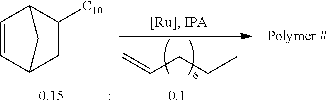

| | | |
|---|---|---|
| Polymer 26 | Mn [kDa] | 4.99 |
| | Mw [kDa] | 9.37 |
| | PDI | 1.88 |
| | Polymer Tg (° C.) | 48 |
| | IR [cm⁻¹] | 3025, 3000, 2925, |
| | | 2853, 1716, |
| | | 1601, 1494, 1448, |
| | | 1317, 1295, 1162, |
| | | 1075, 1031, 965, |
| | | 939, 905, 749, 696 |

### Procedure for the Characterization of Crosslinking of Polymer 26

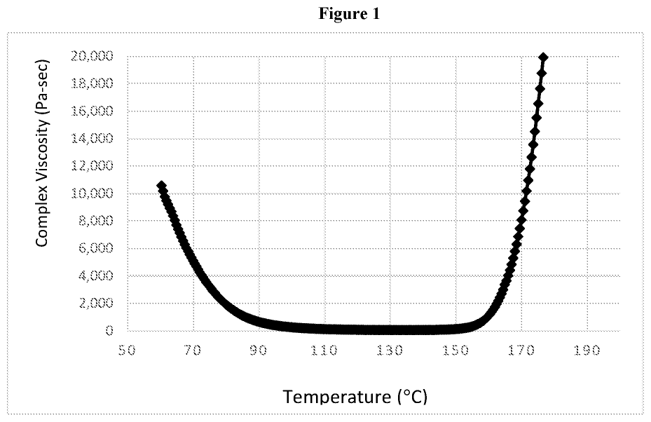

Polymer 26 was dissolved in toluene with Luperox 101 organic peroxide (1 weight percent versus polymer weight). The solvent was evaporated to obtain a dry solid which was molded into 25 mm discs for parallel plate rheometry. In a TA Discovery HR-3 Rheometer, the disc was heated from 60° C. to 200° C. at 5° C. per minute under oscillatory shear to measure the complex viscosity as a function of temperature. See FIG. 1. Those skilled in the art would recognize the behavior in FIG. 1 as typical of a B-staged linear polymer undergoing heat-induced melt flow at decreasing viscosity as temperature rises until crosslinking reactions cause a minimum in the curve and a sharp rise in viscosity leading to gelation or crosslinking.

What is claimed is:

1. A polymer having a dielectric constant Dₖ<3 at 1 to 100 GHz and a dielectric loss D_{f}<0.01 at 1 to 100 GHz, synthesized by ring opening metathesis reactions comprising at least one monomer of Formulae (I), (II), and (III), optionally an olefin of Formula (IV), and at least one metal carbene olefin metathesis catalyst, 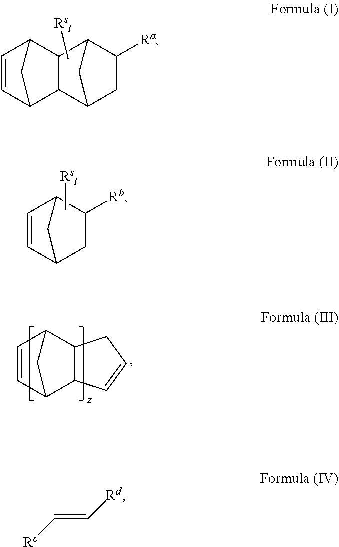
z is 0, 1, 2, or 3;
R^{a} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₈ cycloalkenyl, or —CH₂-(optionally substituted C₃₋₈ cycloalkenyl);
R^{b} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₈ cycloalkenyl, or —CH₂-(optionally substituted C₃₋₈ cycloalkenyl);
R^{c} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₃₋₈₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₈ cycloalkenyl, —CH₂-(optionally substituted C₃₋₈ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{c}R⁴², —C(R^{h})(Rⁱ)C(O)NR^{o}ORⁿ, or together with R^{d} can form a polycyclic ring;
R^{d} is H, optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₈ cycloalkenyl, —CH₂-(optionally substituted C₃₋₈ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, —C(R^{h})(Rⁱ)C(O)NR^{o}ORⁿ, or together with R^{c} can form a polycyclic ring;
each R^{s} is independently optionally substituted linear or branched C₁₋₂₄ alkyl, optionally substituted linear or branched C₂₋₂₄ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₃₋₁₀ cycloalkyl, —CH₂-(optionally substituted C₃₋₁₀ cycloalkyl), optionally substituted C₅₋₂₄ aryl, —CH₂-(optionally substituted C₅₋₂₄ aryl), optionally substituted C₃₋₈ cycloalkenyl, —CH₂-(optionally substituted C₃₋₈ cycloalkenyl), —C(R^{h})(Rⁱ)COOR^{j}, —C(R^{h})(Rⁱ)C(O)H, —C(R^{h})(Rⁱ)C(O)R^{k}, —C(R^{h})(Rⁱ)CR^{l}(OR^{m})(ORⁿ), —C(R^{h})(Rⁱ)C(O)NR^{o}R^{p}, or —C(R^{h})(Rⁱ)C(O)NR^{o}ORⁿ;
t is 0, 1, 2, 3, 4, 5, or 6;
R^{f} is OH, OR^{k}, NR^{g}R^{h}, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R^{g} is H, optionally substituted linear or branched C₁₋₂₄ alkyl, optionally substituted C₃₋₁₀ cycloalkyl, optionally substituted heterocycle, optionally substituted C₅₋₂₄ aryl, optionally substituted linear or branched C₂₋₆ alkenyl, —C(O)-(optionally substituted linear or branched C₂₋₆ alkenyl), or optionally substituted C₃₋₈ cycloalkenyl;
R^{h} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
Rⁱ is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R^{j} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R^{k} is optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R^{l} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R^{m} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
Rⁿ is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R^{o} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl; and
R^{p} is H, optionally substituted linear or branched C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl.

2. The polymer according to claim 1, wherein:
R^{a} is H, optionally substituted linear or branched C₁₋₆ alkyl, optionally substituted linear or branched C₂₋₆ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₃₋₈ cycloalkenyl, or —CH₂-(optionally substituted C₃₋₈ cycloalkenyl);
R^{b} is H, optionally substituted linear or branched C₁₋₆ alkyl, optionally substituted linear or branched C₂₋₆ alkenyl, halogen, —C(O)R^{f}, —CH₂—C(O)R^{f}, —OR^{g}, —CH₂—OR^{g}, CN, NO₂, —CF₃, —P(O)(OH)₂, —OP(O)(OH)₂, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₃₋₈ cycloalkenyl, or —CH₂-(optionally substituted C₃₋₈ cycloalkenyl);
t is 0;
R^{f} is OH, OR^{k}, NR^{g}R^{h}, optionally substituted linear or branched C₁₋₆ alkyl, optionally substituted C₅₋₇ cycloalkyl, optionally substituted heterocycle, optionally substituted C₆₋₁₀ aryl, or optionally substituted C₃₋₈ cycloalkenyl;
R^{g} is H, optionally substituted linear or branched C₁₋₆ alkyl, optionally substituted C₅₋₇ cycloalkyl, optionally substituted heterocycle, optionally substituted C₆₋₁₀ aryl, optionally substituted linear or branched C₂₋₆ alkenyl, —C(O)-(optionally substituted linear or branched C₂₋₆ alkenyl), or optionally substituted C₃₋₈ cycloalkenyl;
R^{h} is H, optionally substituted linear or branched C₁₋₆ alkyl, optionally substituted C₅₋₇ cycloalkyl, optionally substituted heterocycle, optionally substituted C₆₋₁₀ aryl, or optionally substituted C₃₋₈ cycloalkenyl;
R^{k} is optionally substituted linear or branched C₁₋₆ alkyl, optionally substituted C₅₋₇ cycloalkyl, optionally substituted heterocycle, optionally substituted C₆₋₁₀ aryl, or optionally substituted C₃₋₈ cycloalkenyl;
z is 2;
R^{c} is H, optionally substituted linear or branched C₁₋₆ alkyl, optionally substituted linear or branched C₂₋₆ alkenyl, halogen, —C(O)R^{f}, —CH₂—C(O)R^{f}, —OR^{g}, CN, NO₂, —CF₃, —P(O)(OH)₂, —OP(O)(OH)₂, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₆₋₁₀ aryl, —CH₂-(optionally substituted C₆₋₁₀ aryl), optionally substituted C₃₋₈ cycloalkenyl, or —CH₂-(optionally substituted C₃₋₈ cycloalkenyl); and
R^{d} is H, optionally substituted linear or branched C₁₋₆ alkyl, optionally substituted linear or branched C₂₋₆ alkenyl, halogen, —C(O)R^{f}, —CH₂—C(O)R^{f}, —OR^{g}, CN, NO₂, —CF₃, —P(O)(OH)₂, —OP(O)(OH)₂, optionally substituted heterocycle, —CH₂-(optionally substituted heterocycle), optionally substituted C₅₋₇ cycloalkyl, —CH₂-(optionally substituted C₅₋₇ cycloalkyl), optionally substituted C₅₋₂₄ aryl, —CH₂-(optionally substituted C₆₋₁₀ aryl), optionally substituted C₃₋₈ cycloalkenyl, or —CH₂-(optionally substituted C₃₋₈ cycloalkenyl).

3. The polymer according to claim 1, wherein:
R^{a} is optionally substituted linear or branched C₂₋₂₄ alkenyl, optionally substituted linear or branched C₁₋₂₄ alkyl, or optionally substituted C₅₋₂₄ aryl;
z is 2;
R^{b} is optionally substituted linear or branched C₁₋₂₄ alkyl, —CH₂—OR^{g}, —CH₂-(optionally substituted heterocycle), —C(O)R^{f}, optionally substituted heterocycle, spiro optionally substituted heterocycle, —CH₂-(optionally substituted C₅₋₂₄ aryl), or —CH₂—OR^{g};
R^{g} is H, optionally substituted linear or branched C₁₋₂₄ alkyl, —C(O)-(optionally substituted linear or branched C₂₋₆ alkenyl), or optionally substituted C₅₋₂₄ aryl;
R^{f} is OH;
R^{c} is H; and
R^{d} is optionally substituted linear or branched C₁₋₂₄ alkyl, or —CH₂-(optionally substituted heterocycle).

4. The polymer according to claim 1, wherein the at least one monomer of Formula (I) has the structure wherein: R^{a} is 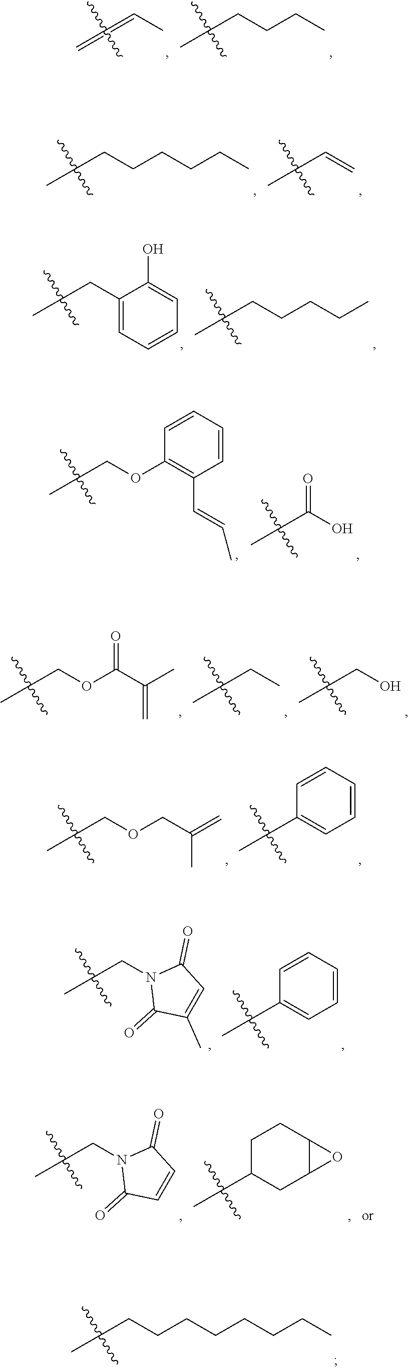
and t=0; the at least one monomer of Formula (II) has the structure wherein: R^{b} is 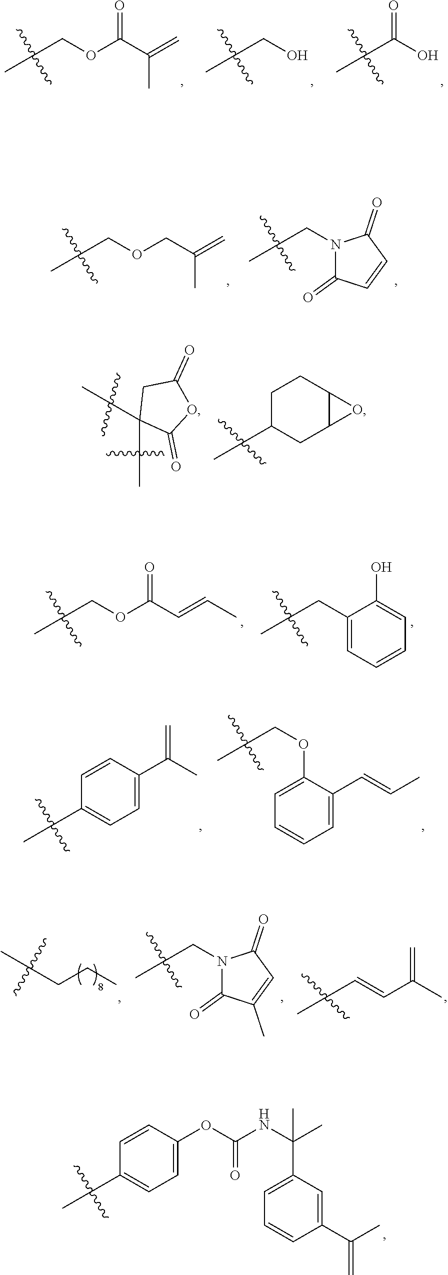 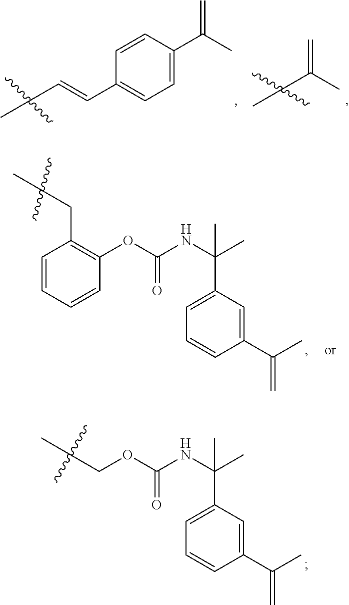
and t=0; the at least one monomer of Formula (III) has the structure wherein z is 1 or 2; and the at least one olefin of Formula (IV) has the structure wherein: R^{c} is 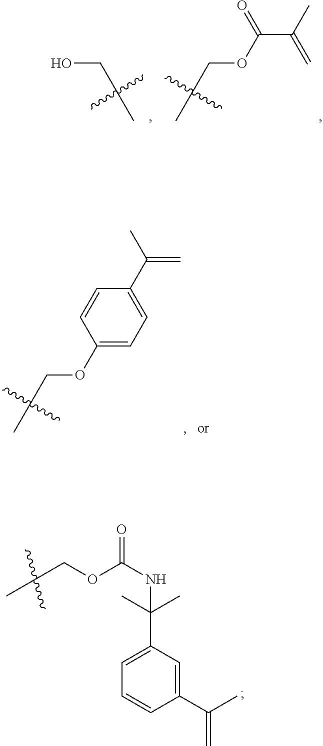
and R^{d} is

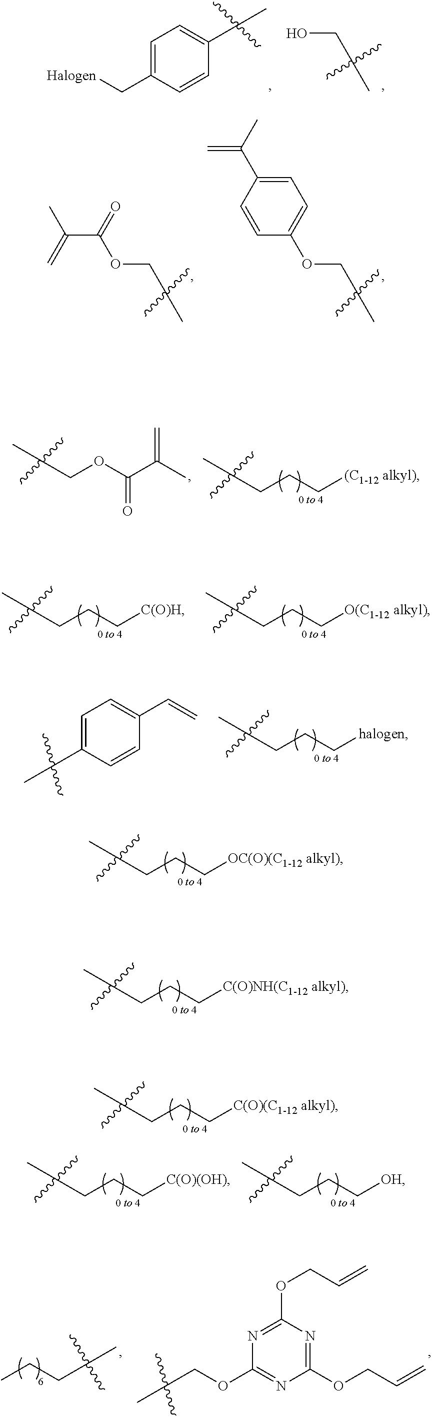

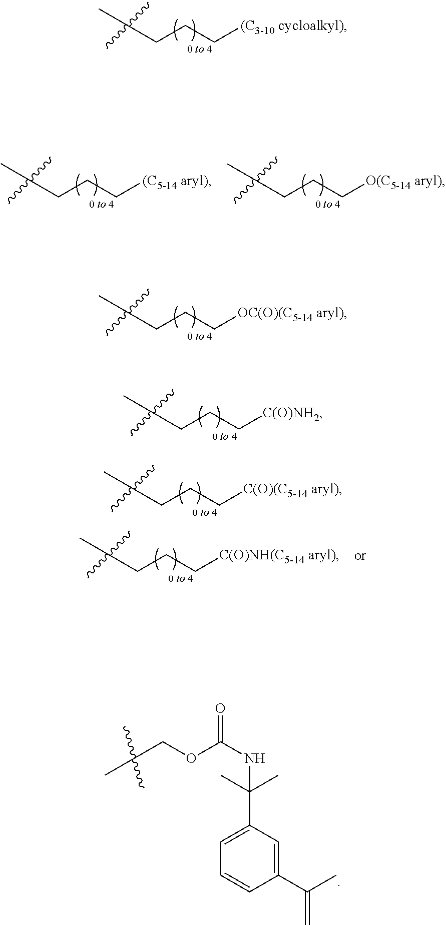

5. The polymer according to claim 1, wherein: the at least one monomer of Formula (I) is 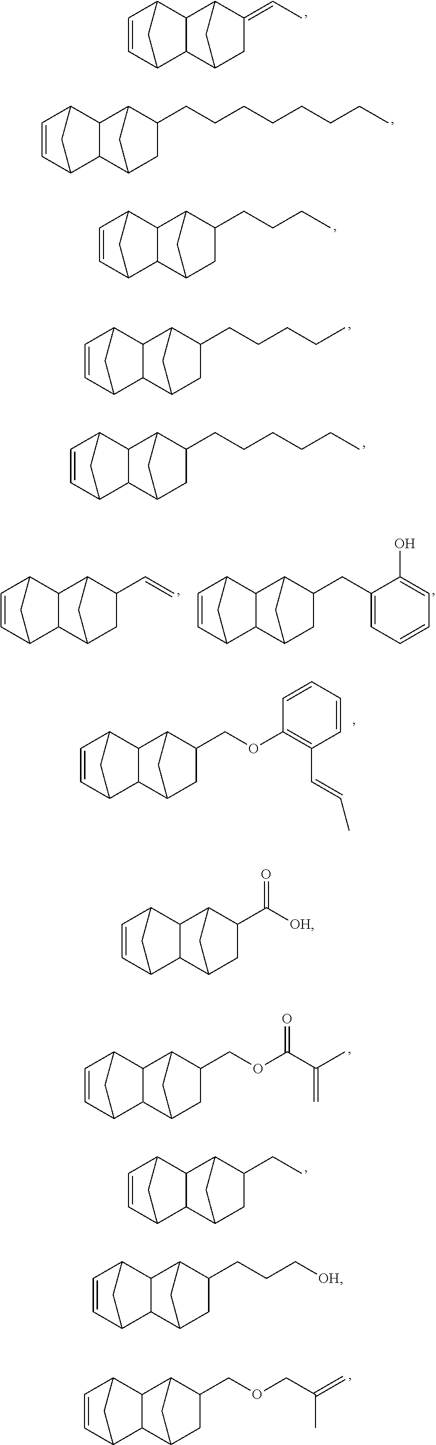 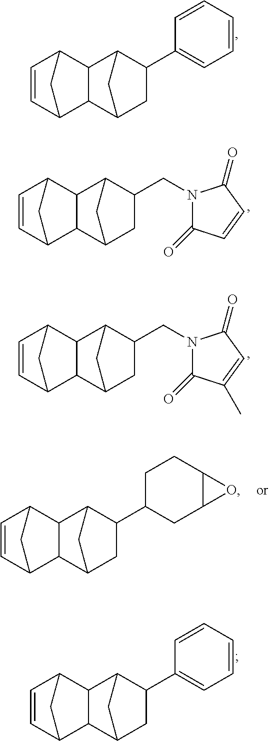
the at least one monomer of Formula II is 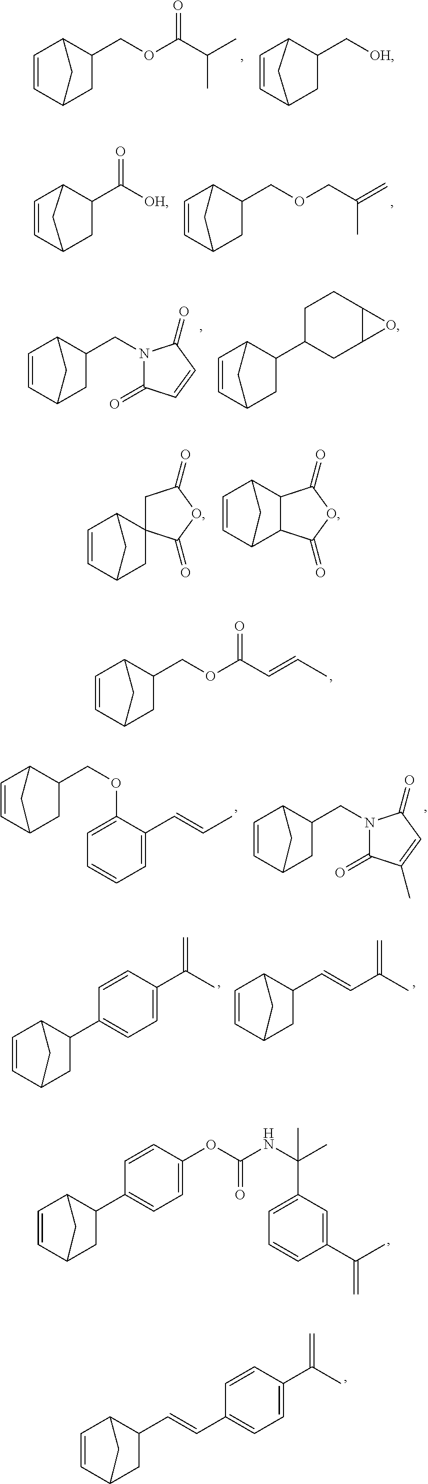 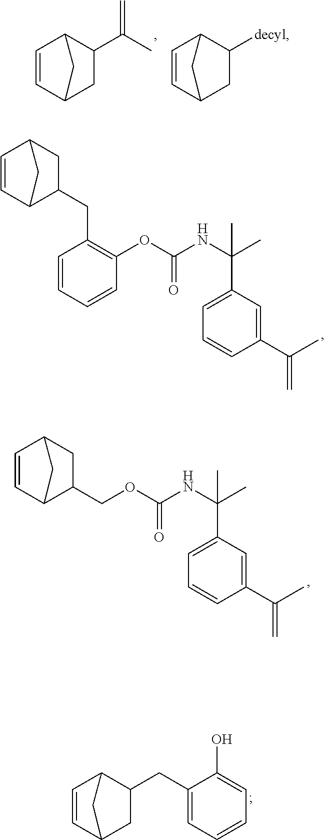
the at least one monomer of Formula (III) is 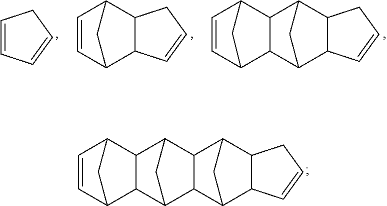
and the at least one olefin of Formula (IV) is

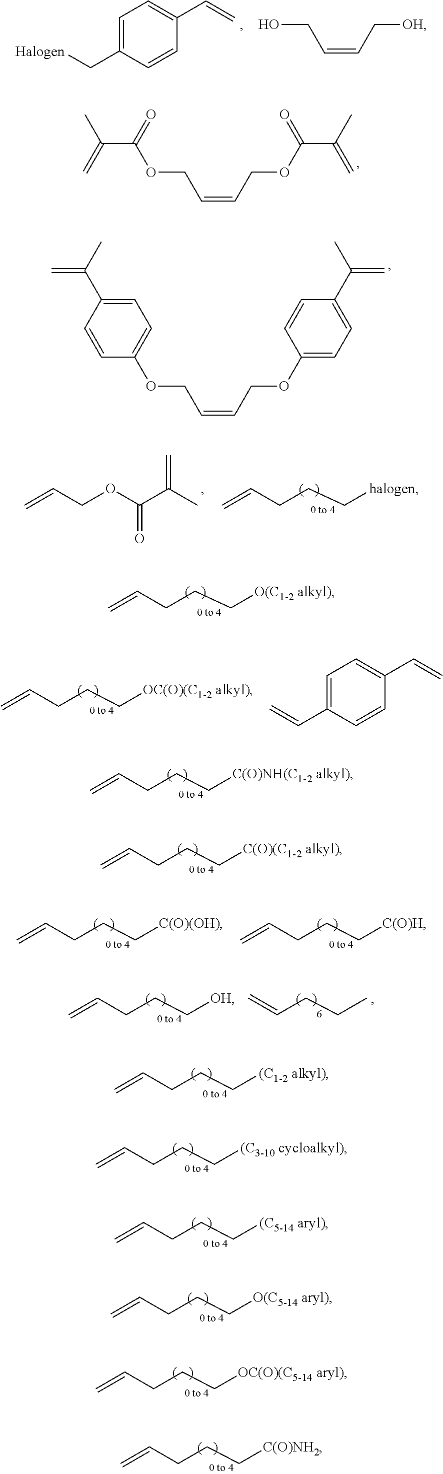

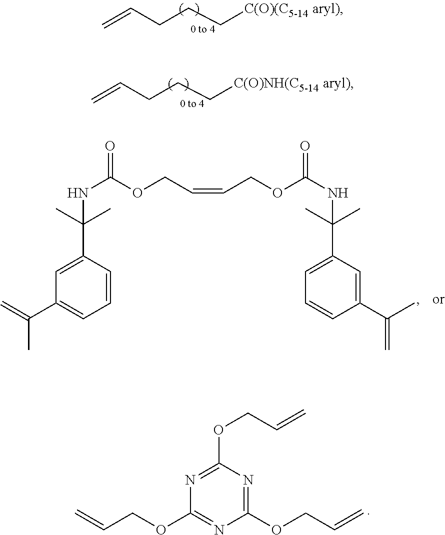

6. The polymer according to claim 1, wherein: the at least one monomer of Formula (I) is 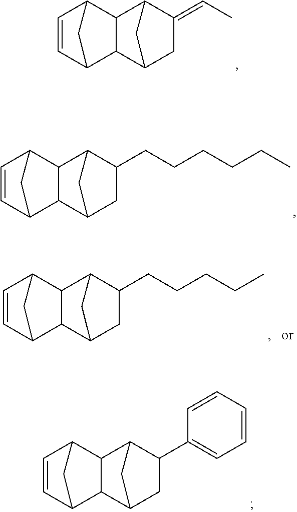
the at least one monomer of Formula (II) is 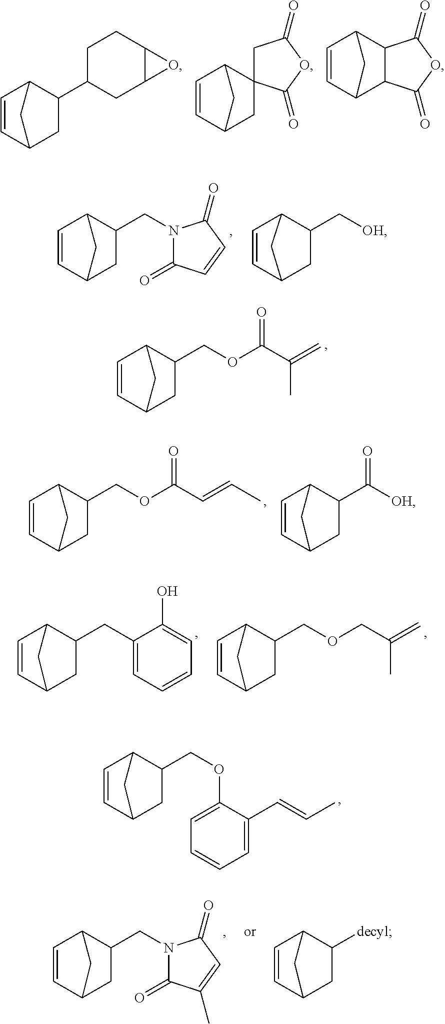
the at least one monomer of Formula (III) is 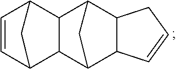 [SMILES: C1=CC2C(C1)C1CC2C2C3C=CC(C3)C12]
and the at least one olefin of Formula (IV) is

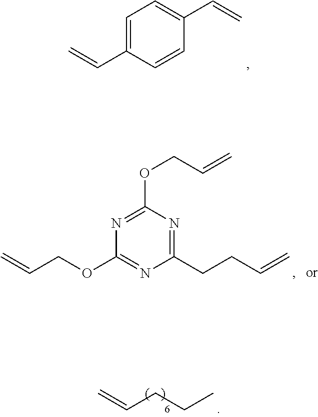

7. The polymer according to any of claims 1-6, wherein the at least one metal carbene olefin metathesis catalyst has the structure of Formula (1): 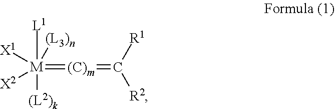
wherein:
M is ruthenium;
L¹, L², and L³ are independently neutral electron donor ligands;
n is 0 or 1;
m is 0, 1, or 2;
k is 0 or 1;
X¹ and X² are independently anionic ligands; and
R¹ and R² are independently hydrogen, optionally substituted hydrocarbyl, optionally substituted heteroatom-containing hydrocarbyl; or R¹ and R² are linked together to form one or more cyclic groups.

8. The polymer according to any of claims 1-6, wherein the at least one metal carbene olefin metathesis catalyst has the structure of Formula (2): 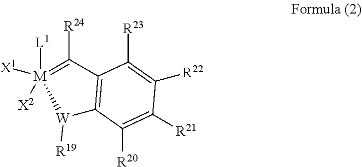
wherein:
L¹ is an independently neutral electron donor ligand;
X¹ and X² are independently anionic ligands;
W is O, halogen, NR³³, or S;
R¹⁹ is H, optionally substituted C₁₋₂₄ alkyl, —C(R³⁴)(R³⁵)COOR³⁶, —C(R³⁴)(R³⁵)C(O)H, —C(R³⁴)(R³⁵)C(O)R³⁷, —C(R³⁴)(R³⁵)CR³⁸(OR³⁹)(OR⁴⁰), —C(R³⁴)(R³⁵)C(O)NR⁴¹R⁴², —C(R³⁴)(R³⁵)C(O)NR⁴¹OR⁴⁰, —C(O)R²⁵, optionally substituted heterocycle, optionally substituted C₃₋₁₀ cycloalkyl, optionally substituted C₅₋₂₄ aryl, optionally substituted C₃₋₈ cycloalkenyl, or when W is NR³³, then R¹⁹ together with R³³ can form an optionally substituted heterocyclic ring or when W is halogen then R¹⁹ is nil;
R²⁰ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R²¹ can form a polycyclic ring;
R²¹ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R²⁰ or together with R²² can form a polycyclic ring;
R²² is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R²¹ or together with R²³ can form a polycyclic ring;
R²³ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R²² can form a polycyclic ring;
R²⁴ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, or optionally substituted C₃₋₈ cycloalkenyl;
R²⁵ is OH, OR³⁰, NR²⁷R²⁸, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R²⁶ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R²⁷ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R²⁸ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R²⁹ is H, optionally substituted C₁₋₂₄ alkyl, OR²⁶, —NR²⁷R²⁸, optionally substituted heterocycle, optionally substituted C₃₋₁₀ cycloalkyl, optionally substituted C₅₋₂₄ aryl, or optionally substituted C₃₋₈ cycloalkenyl;
R³⁰ is optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R³¹ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R³³ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R³⁴ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R³⁵ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R³⁶ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R³⁷ is optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R³⁸ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R³⁹ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R⁴⁰ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R⁴¹ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R⁴² is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl; and
x is 1 or 2.

9. The polymer according to claim 7 or claim 8, wherein L¹ is 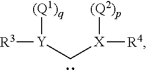
wherein
X and Y are independently C, CR^{3a}, N, O, S, or P;
Q¹, Q², R³, R^{3a}, and R⁴ are independently hydrogen optionally substituted hydrocarbyl, optionally substituted heteroatom-containing hydrocarbyl;
p is 0, when X is O or S, p is 1, when X is N, P, or CR^{3a}, and p is 2, when X is C; and
q is 0, when Y is O or S, q is 1, when Y is N, P, or CR^{3a}, and q is 2, when X is C.

10. The polymer according to claim 7 or claim 8, wherein L¹ is 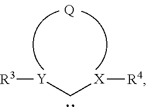
wherein:
Q is a two-atom linkage having the structure —[CR¹¹R¹²]ₛ—[CR¹³R¹⁴]ₜ— or —[CR¹¹═CR¹³]—, wherein R¹¹, R¹², R¹³, and R¹⁴ are independently hydrogen, optionally substituted hydrocarbyl, optionally substituted heteroatom-containing hydrocarbyl;
s and t are independently 1 or 2; or
any two of R¹¹, R¹², R¹³, and R¹⁴ are optionally linked together and can form an optionally substituted, saturated or unsaturated polycyclic ring structure.

11. The polymer according to claim 7 or claim 8, wherein L¹ is 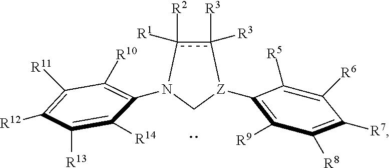
wherein:
Z is N or CR³²;
R¹ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R² can form a spiro compound, or together with R³ or together with R⁴ can form a polycyclic ring;
R² is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R¹ can form a spiro compound, or together with R³ or together with R⁴ can form a polycyclic ring;
R³ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R² or together with R¹ can form a polycyclic ring or together with R⁴ can form a spiro compound;
R⁴ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R³ can form a spiro compound, or together with R² or together with R¹ can form a polycyclic ring;
R⁵ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R⁶ can form an optionally substituted polycyclic ring;
R⁶ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R⁵ or together with R⁷ can form an optionally substituted polycyclic ring;
R⁷ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl optionally substituted C₃₋₈ cycloalkenyl, or together with R⁶ or together with R⁸ can form an optionally substituted polycyclic ring;
R⁸ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R⁷ or together with R⁹ can form an optionally substituted polycyclic ring;
R⁹ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R⁸ can form an optionally substituted polycyclic ring;
R¹⁰ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R¹¹ can form an optionally substituted polycyclic ring;
R¹¹ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R¹⁰ or together with R¹² can form an optionally substituted polycyclic ring;
R¹² is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R¹¹ or together with R¹³ can form an optionally substituted polycyclic ring;
R¹³ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R¹⁴ or together with R¹² can form an optionally substituted polycyclic ring;
R¹⁴ is H, optionally substituted C₁₋₂₄ alkyl, halogen, —C(O)R²⁵, —OR²⁶, CN, —NR²⁷R²⁸, NO₂, —CF₃, —S(O)ₓR²⁹, —P(O)(OH)₂, —OP(O)(OH)₂, —SR³¹, optionally substituted heterocycle, optionally substituted C₃₋₁₀ cycloalkyl, optionally substituted C₅₋₂₄ aryl, optionally substituted C₃₋₈ cycloalkenyl, or together with R¹³ can form a polycyclic ring;
R³² is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R²⁵ is OH, OR³⁰, NR²⁷R²⁸, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R²⁶ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R²⁷ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R²⁸ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R²⁹ is H, optionally substituted C₁₋₂₄ alkyl, OR²⁶, —NR²⁷R²⁸, optionally substituted heterocycle, optionally substituted C₃₋₁₀ cycloalkyl, optionally substituted C₅₋₂₄ aryl, or optionally substituted C₃₋₈ cycloalkenyl;
R³⁰ is optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl;
R³¹ is H, optionally substituted C₁₋₂₄ alkyl, optionally substituted C₃₋₁₀ cycloalkyl, optionally substituted heterocycle, optionally substituted C₅₋₂₄ aryl, or optionally substituted C₃₋₈ cycloalkenyl; and
x is 1 or 2.

12. The polymer according to any of claims 7-11, wherein the ring opening metathesis reactions comprise at least one monomer of Formula (I), and at least one monomer of Formula (II), and at least one metal carbene olefin metathesis catalyst of Formula (1), Formula (2), or mixtures thereof.

13. The polymer according to any of claims 7-11, wherein the ring opening metathesis reactions comprise at least one monomer of Formula (I), and at least one monomer of Formula (II), and at least one olefin of Formula (IV), and at least one metal carbene olefin metathesis catalyst of Formula (1), Formula (2), or mixtures thereof.

14. The polymer according to any of claims 7-11, wherein the ring opening metathesis reactions comprise at least one monomer of Formula (I), and at least one monomer of Formula (II), and at least one monomer of Formula (III), and at least one metal carbene olefin metathesis catalyst of Formula (1), Formula (2), or mixtures thereof.

15. The polymer according to any of claims 7-11, wherein the ring opening metathesis reactions comprise at least one monomer of Formula (II), and at least one monomer of Formula (III), and at least one olefin of Formula (IV), and at least one metal carbene olefin metathesis catalyst of Formula (1), Formula (2), or mixtures thereof.

16. The polymer according to any of claims 7-11, wherein the ring opening metathesis reactions comprise at least one monomer of Formula (I), and at least one monomer of Formula (III), and at least one metal carbene olefin metathesis catalyst of Formula (1), Formula (2), or mixtures thereof.

17. An article of manufacture, comprising the polymer according to any of claims 1-16.

18. The article of manufacture of claim 17, wherein the article of manufacture is selected from the group consisting of a prepreg, a fiber composite laminate, a solvent based coating, a melt-extruded part, a film, and a liquid compound.

19. The polymer according to any of claims 1-16, wherein the polymer is crosslinked optionally in the presence of free-radical initiators, cationic initiators, other curative agents, or mixtures thereof.
